(19) United States
(12) Patent Application Publication
(10) Pub. No.: US 2026/0129549 A1
(43) Pub. Date: May 7, 2026

(54) Multi-link Low Latency Relaying

(71) Applicant: Ofinno, LLC, Reston, VA (US)

(72) Inventors: Serhat Erkucuk, Reston, VA (US); Leonardo Alisasis Lanante, Reston, VA (US); Esmael Hejazi Dinan, McLean, VA (US); Jeongki Kim, Fairfax, VA (US)

(73) Assignee: Ofinno, LLC, Reston, VA (US)

(21) Appl. No.: 19/435,985

(22) Filed: Dec. 30, 2025

Related U.S. Application Data
(63) Continuation of application No. PCT/US2024/036064, filed on Jun. 28, 2024.
(60) Provisional application No. 63/524,269, filed on Jun. 30, 2023.

(51) Int. Cl. H04W 40/12; H04W 60/04; H04W 74/0816

(52) U.S. Cl. CPC H04W 40/12; H04W 74/0816; H04W 60/04

(57) ABSTRACT

A first station (STA) receives a first portion of a first physical layer protocol data unit (PPDU) via a first link from a second STA. Based on the first portion of the first PPDU indicating low latency relaying and comprising an address of the first STA as a first receiver address of the first PPDU, the first STA decodes and forwards a second portion of the first PPDU for transmission in a second PPDU via a second link to a third STA.

### CROSS-REFERENCE TO RELATED APPLICATIONS

This application is a continuation of International Application No. PCT/US2024/036064, filed Jun. 28, 2024, which claims the benefit of U.S. Provisional Application No. 63/524,269, filed Jun. 30, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example reference model for a multi-link device (MLD).

FIG. 8 illustrates an example of an AP MLD and an associated non-AP MLD.

FIG. 9 illustrates an example of a multi-link setup between an AP MLD and a non-AP MLD.

FIG. 10 illustrates an example of a traffic identifier (TID)-to-link mapping in a multi-link communication environment.

FIG. 11 illustrates an example of a sub-1 GHz (S1G) relay architecture.

FIG. 12 illustrates an example of a source-relay-destination link.

FIG. 13 is an example that illustrates relaying with no transmission opportunity (TXOP) protection.

FIG. 14 illustrates an example Request-to-Send (RTS)/Clear-to-Send (CTS) procedure.

FIG. 15 is an example that illustrates relaying with TXOP protection.

FIG. 16 is an example that illustrates the use of a second link by an MLD relay when a first link of the MLD relay is busy.

FIG. 17 is an example that illustrates an MLD relay transmitting via a first link while receiving via a second link.

FIG. 18 is an example that illustrates a relay configuration.

FIG. 19 is an example that illustrates multiple MLD relays transmitting via a link while receiving via another link.

FIG. 20 is an example that illustrates a procedure which may be used to relay low latency data by an MLD relay.

FIG. 21 is an example that illustrates another procedure which may be used to relay low latency data by an MLD relay.

FIG. 22 is an example that illustrates another procedure which may be used to relay low latency data by an MLD relay.

FIG. 23 is an example that illustrates another procedure which may be used to relay low latency data by an MLD relay.

FIG. 24 is an example that illustrates another procedure which may be used to relay low latency data by an MLD relay.

FIG. 25 is an example that illustrates a procedure for protecting a TXOP while performing low latency relaying.

FIGS. 26A-26B illustrate examples of fields which may be used in embodiments of the present disclosure.

FIG. 27 illustrates an example process according to an embodiment.

FIG. 28 illustrates another example process according to an embodiment.

FIG. 29 illustrates another example process according to an embodiment.

FIG. 30 illustrates another example process according to an embodiment.

FIG. 31 illustrates another example process according to an embodiment.

FIG. 32 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of,” as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on,” as used herein, may be interpreted as “based at least in part on” rather than, for example, “based solely on.” The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++, or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

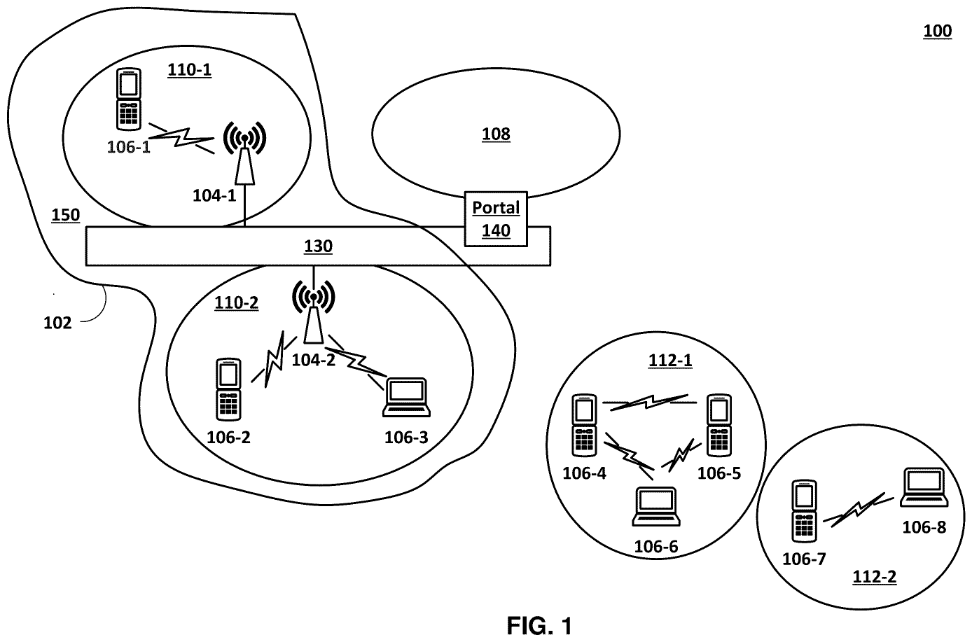

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

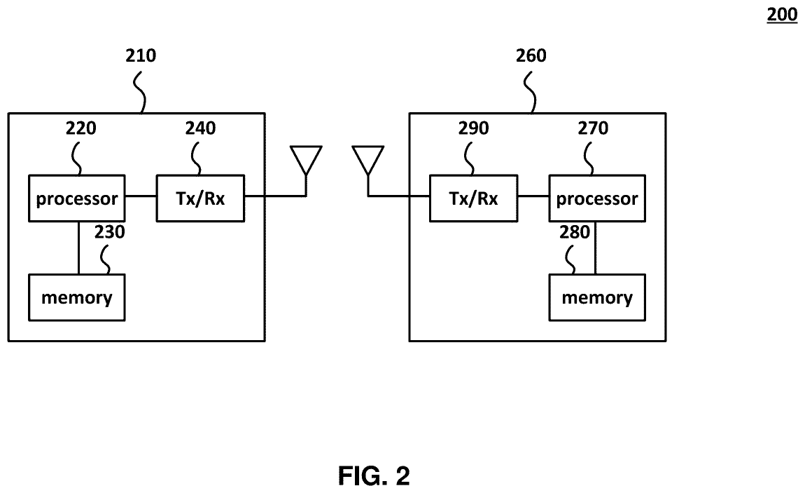

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

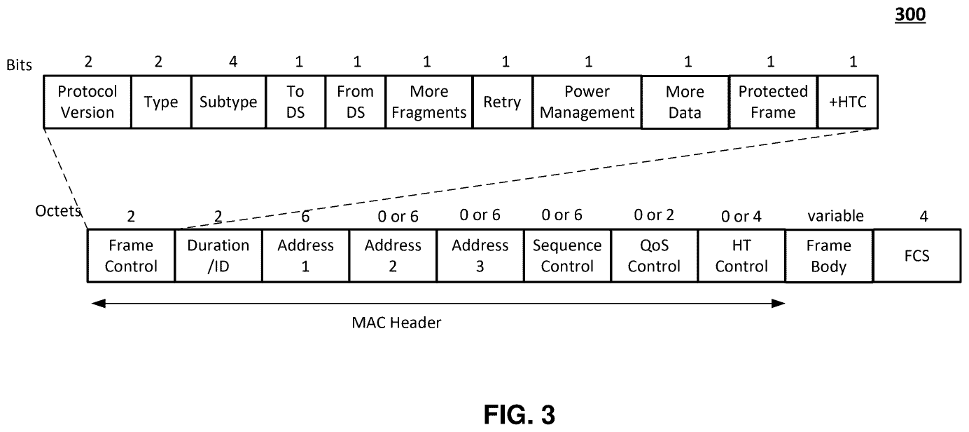

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS,” “From DS,” “More Fragments,” retry, power management, “More Data,” protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield, and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

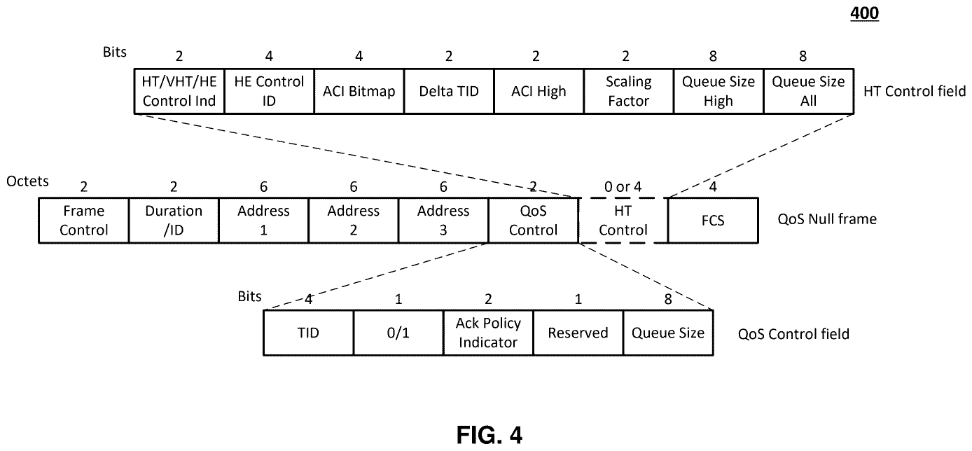

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield.

The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

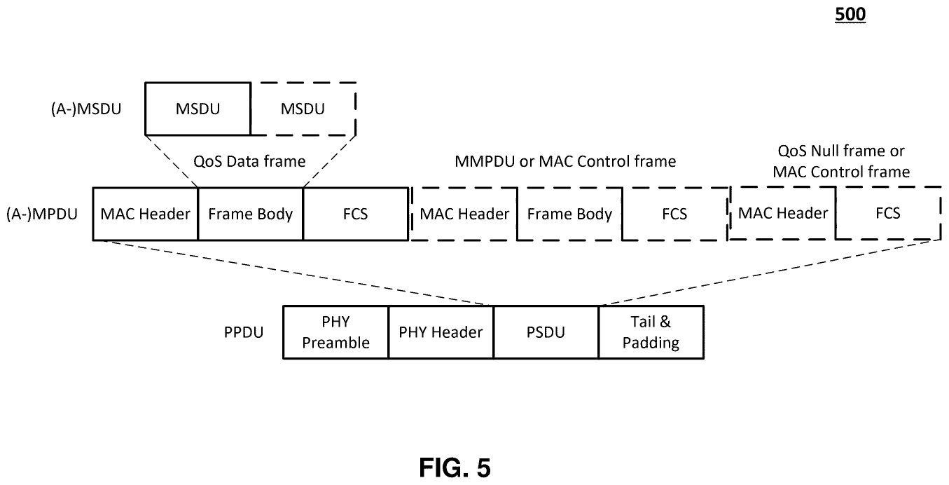

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

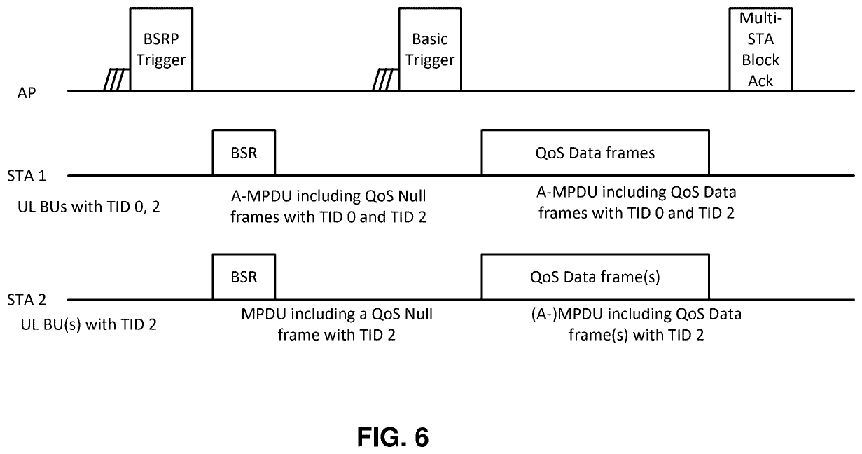

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g., TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID. The AP may acknowledge the transmitted TB PPDUs from STA 1 and STA 2 by sending a multi-STA block ack frame.

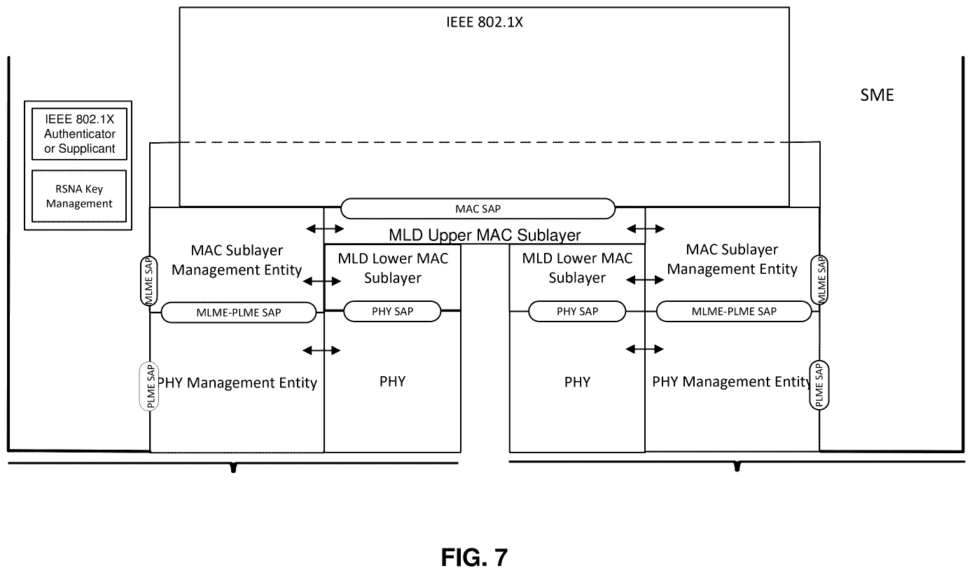

FIG. 7 illustrates an example reference model for a multi-link device (MLD).

An MLD is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both of the communicating AP MLD and non-AP MLD.

As shown in FIG. 7, a MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de) authenticate, (re) associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

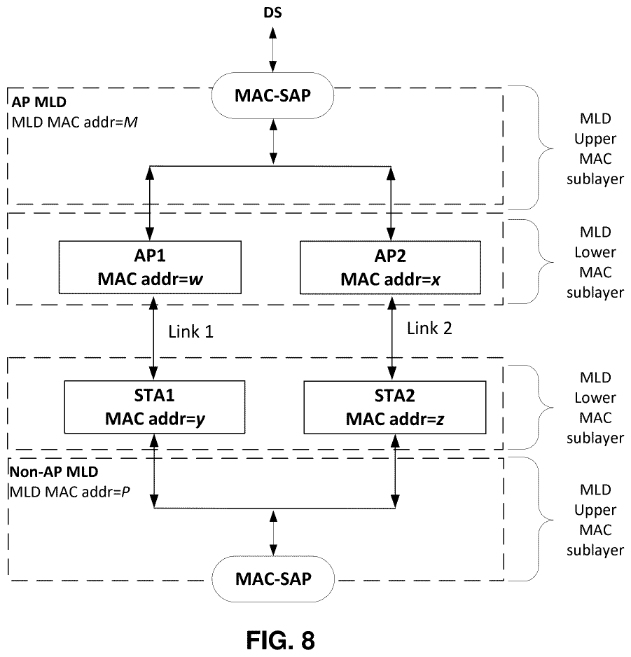

FIG. 8 illustrates an example of an AP MLD and an associated non-AP MLD.

As shown, the AP MLD has two affiliated APs (AP1 and AP2), and the non-AP MLD has two affiliated STAs (STA 1 and STA 2). The AP MLD and the non-AP MLD may be communicatively coupled by two links (Link 1 and Link 2.) Link 1 is established between AP1 and STA1, and link 2 is established between AP2 and STA2.

Generally, the MAC addresses of an MLD and of its affiliated STAs are different from one another. For example, as shown in FIG. 8, the AP MLD may have MAC address M, AP 1 may have MAC address w, and AP2 may have with MAC address x. Similarly, the non-AP MLD may have MAC address P, STA 1 may have MAC address y, and STA2 may have MAC address z.

As shown in FIG. 8, with each MLD, the MAC sublayer may be further divided into an MLD upper MAC sublayer and an MLD lower MAC sublayer. The MLD upper MAC sublayer (MLD) performs functionalities that are common across all links. The MLD lower MAC sublayer performs functionalities that are local to each link. Some of the functionalities require joint processing of both the MLD upper and the MLD lower MAC sublayers.

The MLD upper MAC sublayer functions may include:
Authentication, association, and reassociation (between an AP MLD and a non-AP MLD);
Security association (e.g., pairwise master key security association (PMKSA), pairwise transient key security association (PTKSA) and distribution of group temporal key (GTK)/integrity GTK (IGTK)/beacon IGTK (BIGTK);
Sequence number (SN)/packet number (PN) assignment for frames to be encrypted by pairwise transient key (PTK) for unicast frames;
Encryption/decryption using PTK for unicast frames;
Selection of the MLD lower MAC sublayer for transmission (TID-to-link mapping);
Reordering of packets to ensure in-order delivery per each Block Ack session;
Block Ack scoreboarding for individually addressed frames (in collaboration with the MLD lower MAC sublayer); optionally, the MLD upper MAC sublayer delivers the Block Ack record on one link to the MLD lower MAC sublayer of other links; and
MLD level management information exchange/indication via the MLD lower MAC sublayer

The MLD lower MAC sublayer functions may include:
Maintenance of link specific GTK/IGTK/BIGTK (between an AP affiliated with the AP MLD and a STA affiliated with the non-AP MLD);
Link-specific encryption/decryption/integrity protection and PN assignment using GTK/IGTK/BIGTK (between an AP affiliated with the AP MLD and a STA affiliated with the non-AP MLD);
Link specific management information exchange/indication (e.g., beacon);
Link specific control information exchange/indication (e.g., RTS/CTS, acknowledgements, etc.);
Power save state and mode;
MAC address filtering for frame reception; and
Block Ack scoreboarding for individually addressed frames (in collaboration with the MLD upper MAC sublayer); optionally, the MLD lower MAC sublayer receives the Block Ack record on the other links from the MLD upper MAC sublayer.

Multi-link (re) setup between a non-AP MLD and an AP MLD may include an exchange of (re) association request/response frames. A (re) association request/response frame exchange for a multi-link setup may include both frames carrying a basic multi-link element.

In the (re) association request frame, the non-AP MLD indicates the links that are requested for (re) setup and the capabilities and operational parameters of the requested links. The non-AP MLD may request to (re) set up links with a subset of APs affiliated with the AP MLD. The links that are requested for (re) setup and the capabilities and operation parameters of requested links are independent of existing setup links with an associated AP MLD and the capabilities and operation parameters of setup links.

In the (re) association response frame, the AP MLD may indicate the requested links that are accepted and the requested links that are rejected for (re) setup and the capabilities and operational parameters of the requested links. The AP MLD may accept a subset of the links that are requested for (re) setup. The (re) association response frame is sent to the non-AP STA, affiliated with the non-AP MLD, that sent the (re) association request frame.

An MLD that requests or accepts multi-link (re) setup for any two links ensures that each link is located on a different nonoverlapping channel. After successful multi-link (re) setup between a non-AP MLD and an AP MLD, the non-AP MLD and the AP MLD set up links for multi-link operation, and the non-AP MLD is (re) associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

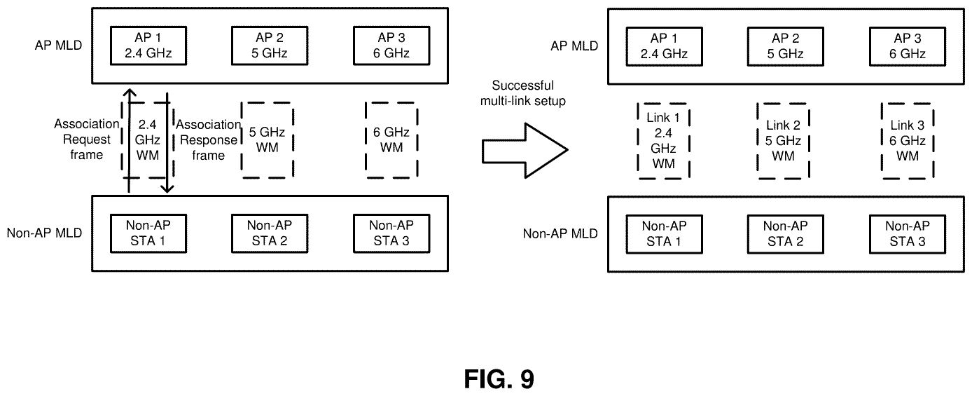

FIG. 9 illustrates an example of a multi-link setup between an AP MLD and a non-AP MLD. As shown, the AP MLD has three affiliated APs: AP 1 operating in the 2.4 GHz band, AP 2 operating in the 5 GHz band, and AP 3 operating in the 6 GHz band. The non-AP MLD has three affiliated STAs: non-AP STA 1 operating in the 2.4 GHZ band, non-AP STA 2 operating in the 5 GHz band, and non-AP STA 3 operating in the 6 GHz band.

The non-AP MLD may initiate multi-link setup by non-AP STA 1 sending an association request frame to AP 1 affiliated with the AP MLD. In the association request frame, the transmitter address (TA) field is set to the MAC address of non-AP STA 1 and the receiver address (RA) field is set to the MAC address of AP 1. The association request frame includes a basic multi-link element that indicates the MLD MAC address of the non-AP MLD and complete information of non-AP STA 1, non-AP STA 2, and non-AP STA 3. The association request frame may request the setup of three links between the non-AP MLD and the AP MLD (a link between AP 1 and non-AP STA 1, a link between AP 2 and non-AP STA 2, and a link between AP 3 and non-AP STA 3).

The AP MLD may respond to the requested multi-link setup by AP sending an association response frame to non-AP STA 1 affiliated with the non-AP MLD. In the association response frame, the TA field is set to the MAC address of the AP 1 and the RA field is set to the MAC address of the non-AP STA 1. The association response frame includes a basic multi-link element that indicates the MLD MAC address of the AP MLD and complete information of AP 1, AP 2, and AP 3. The association response frame signals successful multi-link setup by the setup of three links between the non-AP MLD and AP MLD (link 1 between AP 1 and non-AP STA 1, link 2 between AP 2 and non-AP STA 2, and link 3 between AP 3 and non-AP STA 3).

By default, all TIDs at the non-AP MLD are mapped to all setup links for both uplink and downlink. The TID-to-link mapping mechanism allows an AP MLD and a non-AP MLD that performed or are performing multi-link setup to specify how UL and DL QoS traffic corresponding to different TIDs (e.g., between 0 and 7) may be assigned to the setup links. In a negotiated TID-to-link mapping, a TID may be mapped to a link set, which is a subset of setup links, ranging from a single setup link to all the setup links.

A setup link is defined as enabled for a non-AP MLD if at least one TID is mapped to that link either in DL or in UL, and is defined as disabled if no TIDs are mapped to that link both in DL and UL. At any point in time, a TID is always mapped to at least one setup link both in DL and UL, which means that a TID-to-link mapping change can only be valid and successful if it does not result in a TID having a mapped link set made of zero setup links.

By default, all setup links are enabled. If a link is enabled for a non-AP MLD, it may be used for the exchange of individually addressed frames, subject to the power state of the non-AP STA operating on that link. Only MSDUs or A-MSDUs with TIDs mapped to a link may be transmitted on that link in the direction (DL/UL) corresponding to the TID-to-link mapping. Individually addressed management frames and control frames may be sent on any enabled link between an affiliated STA of the non-AP MLD and a corresponding AP of the AP MLD, both in DL and UL.

If a link is disabled for a non-AP MLD, the link may not be used for the exchange of individually addressed frames between an affiliated STA of the non-AP MLD and a corresponding AP of the AP MLD.

If a TID is mapped in UL to a set of enabled links for a non-AP MLD, the non-AP MLD may use any link within this set of enabled links to transmit individually addressed MSDUs or A-MSDUs corresponding to that TID.

If a TID is mapped in DL to a set of enabled links for a non-AP MLD, the non-AP MLD may retrieve individually addressed BUs buffered at the AP MLD that are MSDUs or A-MSDUs corresponding to the TID, on any link of the set of enabled links. Conversely, the AP MLD may use any link within the set of enabled links to transmit individually addressed MSDUs or A-MSDUs corresponding to the TID, subject to the power state of the non-AP STA on each of the used links.

If the default mode is used, the non-AP MLD may retrieve BUs buffered by the AP MLD on any setup link, though the AP MLD may recommend a link.

A non-AP MLD may retrieve buffered BUs that are MMPDUs buffered at the AP MLD on any enabled link. An AP MLD may use any enabled link to transmit individually addressed bufferable management frames that are not measurement MMPDUs, subject to the power state of the non-AP STA on the used link.

If a STA affiliated with a non-AP MLD is in active mode on a link with a set of TIDs mapped for DL transmission, its associated AP affiliated with the AP MLD may transmit to the STA: MSDUs/A-MSDUs for the set of mapped TIDs for the non-AP MLD; and MMPDUs that are not measurement MMPDUs for the non-AP MLD or its affiliated STAs, unless the frames are transmitted to another STA affiliated with the same non-AP MLD and in active mode.

As mentioned above, under the default mapping mode, all TIDs are mapped to all setup links for DL and UL, and all setup links are enabled. A non-AP MLD and an AP MLD that perform multi-link setup shall operate under this mode if a TID-to-link mapping negotiation for a different mapping has not occurred, was unsuccessful, or was torn down.

In a multi-link (re) setup procedure, a non-AP MLD may initiate a TID-to-link mapping negotiation by including a TID-to-link mapping element in a (re) association request frame if an AP MLD has indicated support for TID-to-link mapping negotiation.

After receiving the (re) association request frame containing the TID-to-link mapping element, the AP MLD may reply to the (re) association request frame according to the following rules. The AP MLD can accept the requested TID-to-link mapping indicated in the TID-to-link mapping element in the received (re) association request frame only if it accepts the multi-link (re) setup for all links on which at least one TID is requested to be mapped. In this case, the non-AP MLD does include in the (re) association response frame a TID-to-link mapping element. Otherwise, the non-AP MLD indicates rejection of the proposed TID-to-link mapping by including in the (re) association response frame a TID-to-link mapping element that suggests a preferred TID-to-link mapping.

Following a successful multi-link (re) setup, to negotiate a new TID-to-link mapping, an initiating MLD may send an individually addressed TID-to-link mapping request frame to a responding MLD that has indicated support of TID-to-link mapping negotiation.

On receiving the individually addressed TID-to-link mapping request frame, the responding MLD sends an individually addressed TID-to-link mapping response frame to the initiating MLD according to the following rules. The responding MLD may accept the requested TID-to-link mapping indicated in the TID-to-link mapping element in the received TID-to-link mapping request frame by transmitting a TID-to-link mapping response frame. Otherwise, the responding MLD may indicate rejection of the proposed TID-to-link mapping in the TID-to-link mapping response frame. The responding MLD may suggest a preferred TID-to-link mapping in the TID-to-link mapping response frame by including the TID-to-link mapping element in the TID-to-link mapping response frame.

An MLD may suggest a preferred TID-to-link mapping to a peer MLD by sending an unsolicited TID-to-link mapping response frame that includes a TID-to-link mapping element.

When a peer MLD indicates a preferred TID-to-link mapping, an MLD may take into account the preferred TID-to-link mapping when it initiates a new TID-to-link mapping. In addition, an AP MLD may take into account the traffic flow(s) affiliated with the non-AP MLD and the capabilities and constraints (if any) of the non-AP MLD.

When two MLDs have negotiated a TID-to-link mapping, MLD may tear down the negotiated TID-to-link mapping by sending an individually addressed TID-to-link mapping teardown frame. After teardown, the MLDs operates in default mapping mode.

When an MLD successfully negotiates a TID-to-link mapping with a peer MLD, both the MLD and the peer MLD update an uplink and/or downlink TID-to-link mapping information according to the negotiated the TID-to-link mapping.

When an MLD has successfully negotiated with a peer MLD an uplink and/or downlink TID-to-link mapping in which the bit position i of a link mapping field n in the TID-to-link mapping element is set to 0, a TID n shall not be mapped to the link associated with the link ID i in uplink and/or downlink. When an MLD has successfully negotiated with a peer MLD an uplink and/or downlink TID-to-link mapping in which the bit position i of a link mapping field n in the TID-to-link mapping element is set to 1, the TID n is mapped to the link associated with the link ID i in uplink and/or downlink.

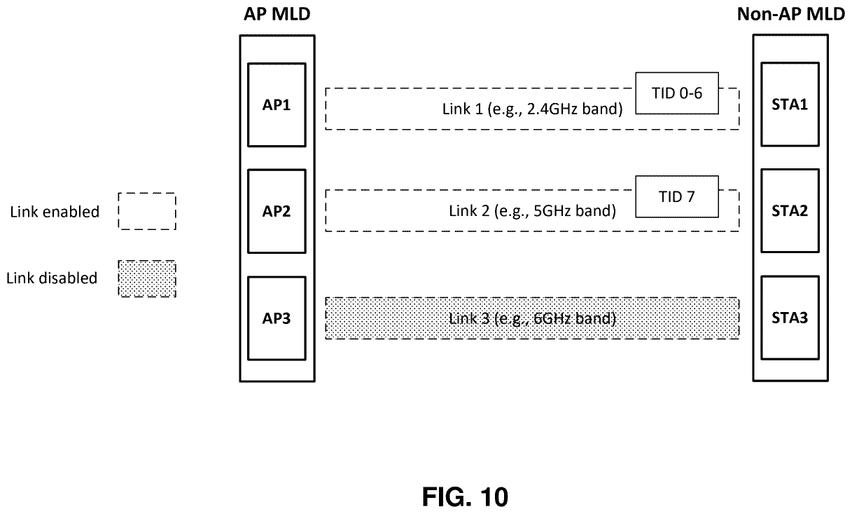

FIG. 10 illustrates an example of a TID-to-link mapping in a multi-link communication environment. As shown, the multi-link communication environment includes an AP MLD having three affiliated APs and a non-AP MLD having three affiliated STAs.

During or after multi-link setup, the non-AP MLD and the AP MLD may negotiate a TID-to-link mapping. The TID-to-link mapping maps TIDs at the non-AP MLD in UL and DL to setup links between the AP MLD and the non-AP MLD. For example, as shown in FIG. 10, the TID-to-link mapping may map TIDs 0-6 in both UL and DL to link 1 and TID 7 in both UL and DL to link 2. As such, links 1 and 2 are enabled, and link 3 is disabled. The TID-to-link mapping negotiation may be performed by exchanging an association request/response frame or a TID-to-link mapping request/response frame between the non-AP MLD and the AP MLD.

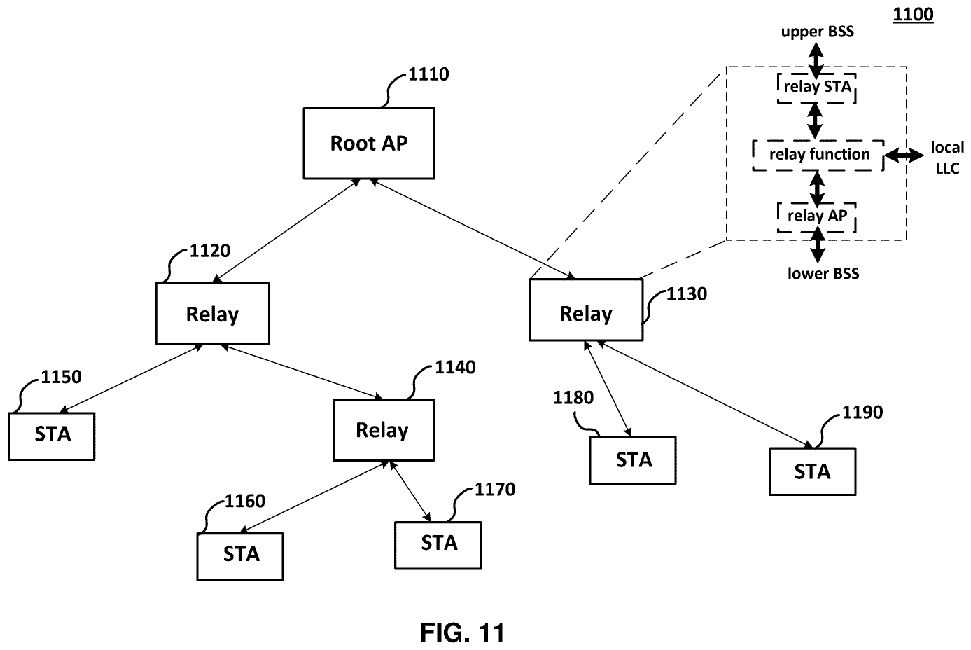

FIG. 11 illustrates an example 1100 of a sub-1 GHz (S1G) relay architecture. Example S1G relay architecture 1100 may be an example according to the S1G relay operation as defined in section 10.54.1 of the IEEE 802.11 standard draft “IEEE P802.11-REVme™/D2.1, January 2023.” As shown in FIG. 11, example S1G relay architecture 1100 may include a root AP 1110, relays 1120, 1130 and 1140, and STAs 1150, 1160, 1170, 1180 and 1190.

S1G relay is a mechanism for expanding the coverage area of an AP, referred to as the root AP. In example S1G relay architecture 1100, the S1G relay mechanism is being used to expand the coverage area of root AP 1110.

As shown in FIG. 11, S1G relays 1120, 1130 and 1140 may each comprise a relay AP, a relay STA, and a relay function. The relay STA communicates with an upper BSS, whereas the relay AP communicates with a lower BSS. The relay function performs local reception or selective forwarding of MSDUs between the relay STA and the relay AP, based on destination address. In an example, relays 1120 and 1130 are associated with root AP 1110. Relay 1140 may be associated with relay 1120. In an example, STA 1150 is associated with relay 1120. STAs 1160 and 1170 may be associated with relay 1140. STAs 1180 and 1190 may be associated with relay 1130.

In an example, frames from STA 1150 are forwarded via the relay function of relay 1120 (from the relay AP to the relay STA of relay 1120) to root AP 1110. In the reverse direction, frames from root AP 1110 are forwarded to STA 1150 via the relay function of relay 1120 (from the relay STA to the relay AP of relay 1120). Similarly, STAs 1180 and 1190 may communicate with root AP 1110 via relay 1130 in both directions (e.g., uplink and downlink). On the other hand, STAs 1160 and 1170 may use relays 1140 and 1120 consecutively to communicate with root AP 1110.

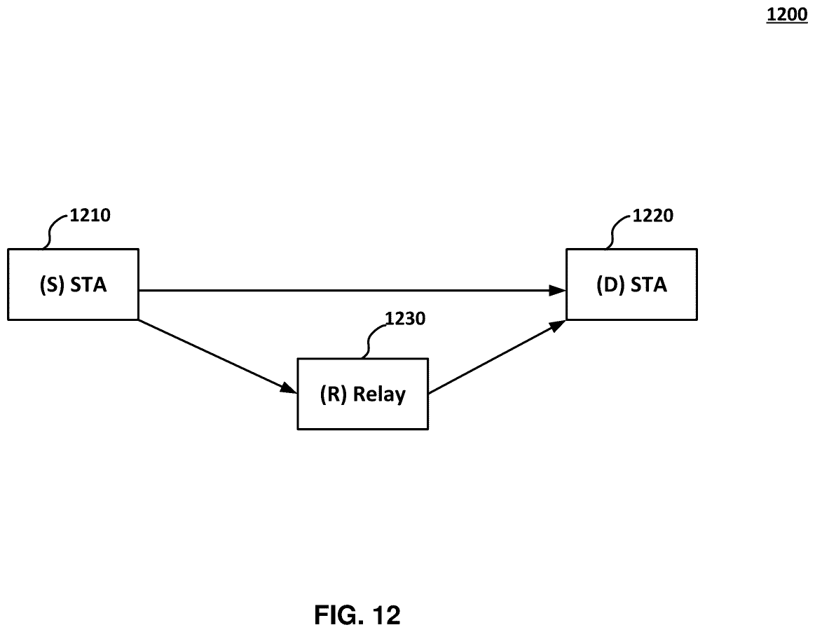

FIG. 12 illustrates an example 1200 of a source-relay-destination link. As shown in FIG. 12, example 1200 may comprise a STA 1210 as a source STA, a STA 1220 as a destination STA, and a relay 1230.

STA 1210 may be a non-AP STA or an AP STA. Similarly, STA 1220 may be a non-AP STA or an AP STA. Relay 1230 may comprise a relay AP, a relay STA, and a relay function as described in FIG. 11 above. In an embodiment, STA 1210 may be an AP STA and STA 1220 may be a non-AP STA, or vice versa. In another embodiment, STAs 1210 and 1220 both may be AP STAs or non-AP STAs. STAs 1210 and 1220 may communicate directly.

Due to unreliable communication or to extend the range of existing communication, source STA 1210 may use relay 1230 to communicate with a destination STA 1220. As such, STA 1210 may transmit data frames destined to STA 1220 via relay 1230. Source STA 1210 and/or the relay 1230 may choose to protect the transmitted data frames with TXOP protection while relaying the data frames via relay 1230. In another embodiment, source STA 1210 and/or relay 1230 may choose not to protect the data frames with TXOP protection while relaying the data frames via relay 1230.

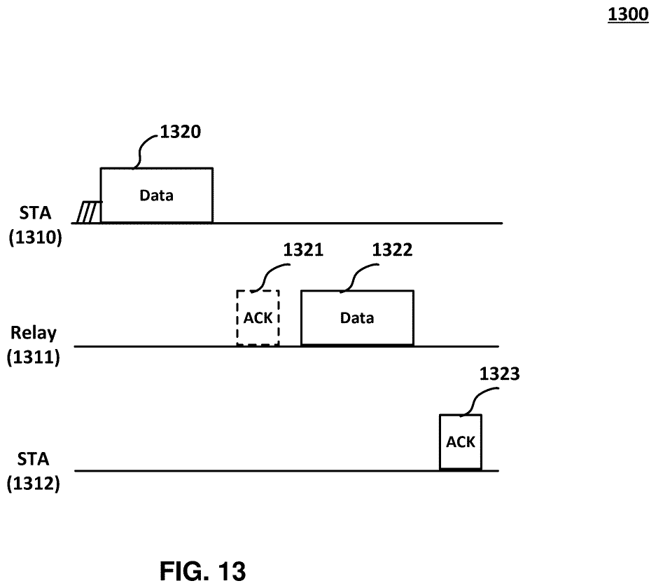

FIG. 13 is an example 1300 that illustrates relaying with no transmission opportunity (TXOP) protection. Example 1300 may be an example according to the TXOP sharing procedures for S1G relay operation as defined in section 10.54.5 of the IEEE 802.11 standard draft “IEEE P802.11-REVme™/D2.1, January 2023.” As shown in FIG. 13, example 1300 may include STAs 1310 and 1312 and relay 1311.

In example 1300, STA 1310 may be a STA that supports TXOP sharing procedures. As shown in FIG. 13, STA 1310 may transmit a data frame 1320 destined to STA 1312 via relay 1311. Data frame 1320 may be a protocol version 1 (PV1) QoS data frame. In an implementation, STA 1310 may set a Relayed Frame field in a Frame Control field of data frame 1320 to 1. The Relayed Frame field set to 1 indicates a relay-shared TXOP. On receiving data frame 1320 with the Relay Frame field set to 1, relay 1311 may transmit an ACK frame 1321 if an explicit ACK procedure is used. Alternatively, relay 1311 may not transmit an ACK frame if an implicit ACK procedure is used.

In example 1300, relay 1311 may transmit data frame 1322 to STA 1312 without protecting data frame 1322. STA 1312 may transmit an ACK frame 1323 after receiving data frame 1322 from relay 1311. Relaying without TXOP protection may allow a lower latency transmission of data frame 1320 from STA 1310 to STA 1312. However, communication may be less reliable in case that other STAs of the same BSS may be present within the communication ranges of STAs 1310, 1312 and relay 1311. To improve communication reliability, an RTS/CTS procedure may be used to protect relayed data frames as further described below.

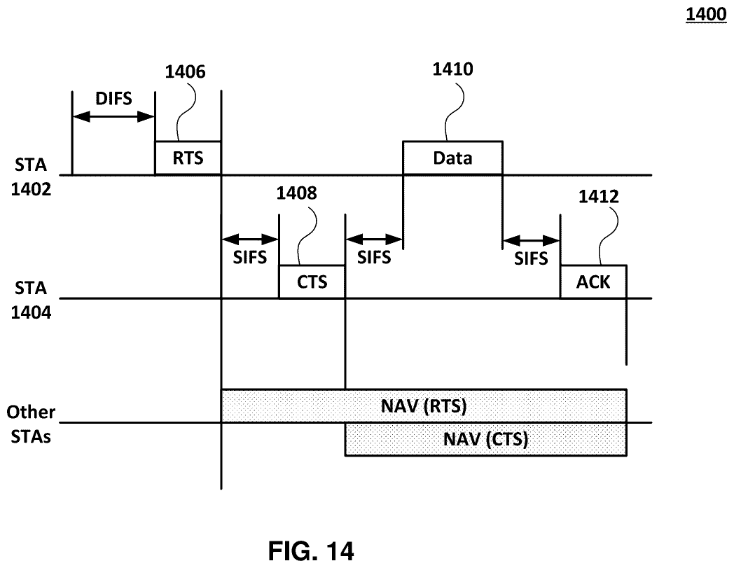

FIG. 14 illustrates an example 1400 of a Request-to-Send (RTS)/Clear-to-Send (CTS) procedure. Example RTS/CTS procedure 1400 may be an example according to the RTS/CTS procedure as defined in section 10.3.2.9 of the IEEE 802.11 standard draft “IEEE P802.11-REVme™/D2.1, January 2023.” As shown in FIG. 14, example RTS/CTS procedure 1400 may include STAs 1402 and 1404. Other STAs of the same BSS may also be within communication range of STAs 1402 and 1404.

In an example, STA 1402 may transmit an RTS frame 1406 to STA 1404. STA 1402 may transmit RTS frame 1406 to protect from hidden STA(s) the transmission of a data frame 1410 that STA 1402 intends to transmit. RTS frame 1406 may include a Duration/ID field. The Duration/ID field may be set to the time, in microseconds, required to transmit data frame 1410, plus one CTS frame, plus one ACK frame (if required), plus three SIFS (Short Interframe Spacing) periods.

In an example, STA 1404 may respond to RTS frame 1406 by transmitting a CTS frame 1408 to STA 1402. CTS frame 1408 may be transmitted one SIFS period after RTS frame 1406. STA 1404 may respond to RTS frame 1406 when RTS frame 1406 is addressed to STA 1404 and after considering the NAV, unless the NAV was set by a frame originating from STA 1402. STA 1404 may respond to the RTS frame 1406 when RTS frame 1406 is addressed to STA 1404 and if the NAV indicates idle. For a non-S1G STA, the NAV indicates idle when the NAV count is 0 or when the NAV count is non-zero but a nonbandwidth signaling TA obtained from a TA field of RTS frame 1406 matches a saved TXOP holder address. For an S1G STA, the NAV indicates idle when both the NAV and RID (response indication deferral) counters are 0 or when either the NAV or RID counter is non-zero but the TA field of RTS frame 1406 matches the saved TXOP holder address.

STA 1404 may set an RA field of CTS frame 1408 to a nonbandwidth signaling TA obtained from the TA field of RTS frame 1406. STA 1404 may set a Duration field of CTS frame 1408 based on the Duration/ID field of RTS frame 1406, namely as equal to the value of the Duration/ID field of RTS frame 1406, adjusted by subtracting the time required to transmit CTS frame 1408 and one SIFS period.

Upon receiving CTS frame 1408, STA 1402 may wait one SIFS period before transmitting data frame 1410. STA 1404 may transmit an ACK frame 1412 in response to data frame 1410. STA 1404 may transmit ACK frame 1412 one SIFS after receiving data frame 1010.

As shown in example 1400, other STAs within communication range of STAs 1402 and 1404, and belonging to the same BSS, may set their NAVs according to RTS frame 1406 and/or CTS frame 1408. For example, a STA receiving RTS frame 1406 may set its NAV based on the Duration/ID field of RTS frame 1406. Another STA receiving CTS frame 1408 may set its NAV based on the Duration field of CTS frame 1408. As such, the other STAs may not access the channel using EDCA until the end of transmission of ACK frame 1412.

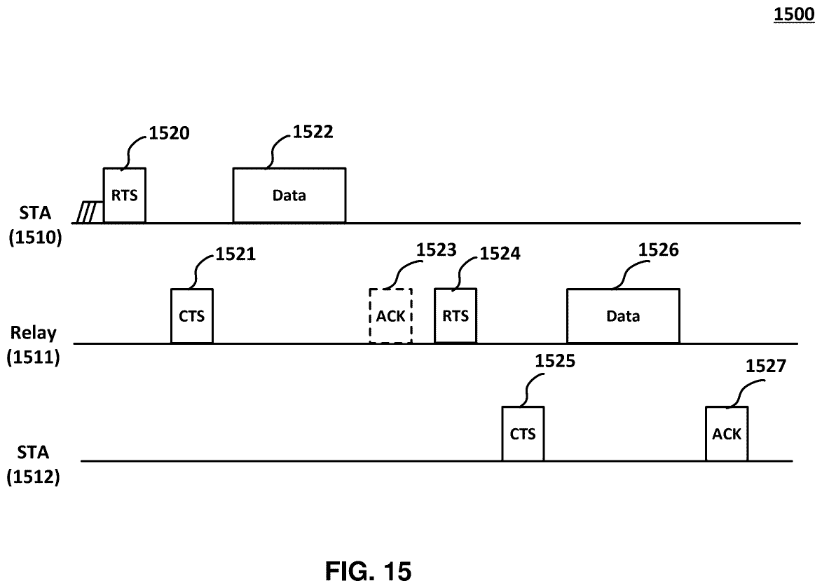

FIG. 15 is an example 1500 that illustrates relaying with TXOP protection. Example 1500 may be an example according to the TXOP sharing procedures for S1G relay operation as defined in section 10.54.5 of the IEEE 802.11 standard draft “IEEE P802.11-REVme™/D2.1, January 2023.” As shown in FIG. 15, example 1500 may include STAs 1510 and 1512 and relay 1511.

In an example, STA 1510 may be a STA that supports TXOP sharing procedures. Before transmitting a data frame 1522 to relay 1511, STA 1510 may transmit an RTS frame 1520 to relay 1511. Relay 1511 may respond to RTS frame 1520 by transmitting a CTS frame 1521 to STA 1510, if its NAV indicates idle. Upon receiving CTS frame 1521, STA 1510 may transmit data frame 1522 to relay 1511. Relay 1511 may transmit an ACK frame 1523 if an explicit ACK procedure is used. Alternatively, relay 1511 may not transmit an ACK frame if an implicit ACK procedure is used.

Similarly, before relaying received data frame 1522 onto STA 1512, relay 1511 may transmit an RTS frame 1524 to STA 1512. STA 1512 may respond to RTS frame 1524 by transmitting a CTS frame 1525 to relay 1511, if its NAV indicates idle. Upon receiving CTS frame 1525, relay 1511 may transmit a data frame 1526 (relay of data frame 1522) to STA 1512. STA 1512 may transmit an ACK frame 1527 to relay 1511 after receiving data frame 1526.

Relaying with TXOP protection provides a more reliable approach to transmit data frames from a source STA to a destination STA. However, communication may be delayed in the presence of other STAs communicating with the destination STA.

It is anticipated that future IEEE 802.11 standards provide various mechanisms to support the quality of service (QOS) requirements of low latency (LL) (or latency sensitive) traffic. Such traffic may originate from various real time applications having stringent latency requirements (e.g., very low average latency, a worst-case latency of the order of a few to tens of milliseconds, and/or a small jitter). In operation, LL traffic may be associated with one or more traffic identifiers (TIDs) associated with one or more predetermined ACs or traffic streams (hereinafter TIDs associated with LL traffic are called LL TIDs). The one or more predetermined ACs may comprise the access categories for video (AC_VI) and voice (AC_VO), for example.

As future IEEE 802.11 radios (e.g., Ultra-High Reliability (UHR) 802.11 radios) are expected to support low latency traffic transmission, STAs with MLD capabilities (hereinafter “MLD STAs”) may be considered for relaying in future IEEE 802.11 radio operations. Such MLD STAs with relay capabilities are hereinafter called “MLD relays.” When a first link of an MLD relay is busy, a second link of the MLD relay may be used by the MLD relay to transmit data to a destination STA to reduce the transmission delay.

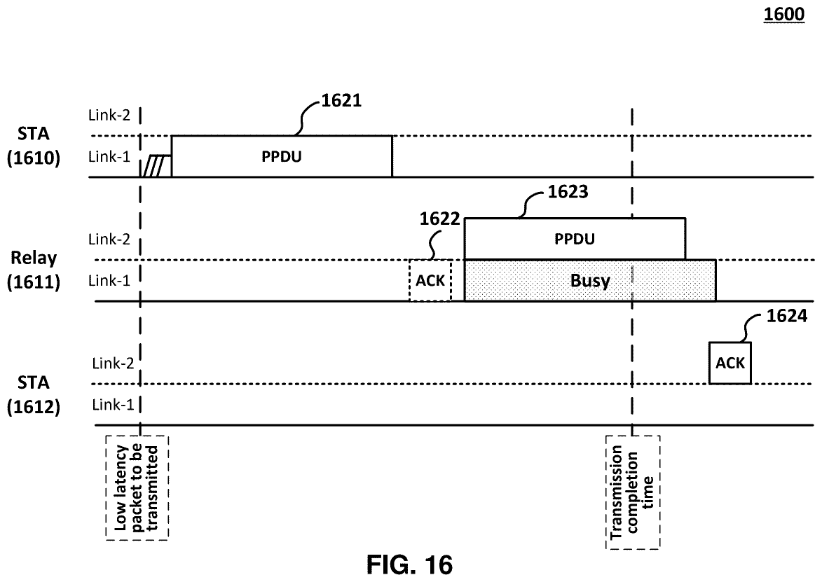

FIG. 16 is an example 1600 that illustrates the use of a second link by an MLD relay when a first link of the MLD relay is busy. As shown in FIG. 16, example 1600 includes a relay 1611 and a plurality of STAs 1610 and 1612. STA 1610 may be a source STA, and STA 1612 may be a destination STA. Relay 1611 and STAs 1610 and 1612 may each comprise an AP MLD or a non-AP MLD capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In example 1600, STA 1610 may have a low latency data frame to transmit to STA 1612 via relay 1611 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 1610 may associate a counter with the transmission completion time. The transmission completion time counter may start with the initiation of the relaying procedure by STA. In another implementation, the transmission completion time counter may start with the transmission of the low latency data frame by STA 1610. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to an existing procedure, STA 1610 may directly transmit a PPDU 1621, comprising the low latency data frame, to relay 1611 via a first link (e.g., Link-1), if no TXOP protection is used. In another example, TXOP protection may be supported by implementing an RTS-CTS exchange before the transmission of PPDU 1621. In an example, PPDU 1621 may comprise multiple MPDUs. In an example, PPDU 1621 may comprise a single MPDU. Upon receiving PPDU 1621, relay 1611 decodes the PHY header, MAC header, and frame body of PPDU 1621 and performs FCS control. If PPDU 1621 is received correctly, relay 1611 may transmit an ACK frame 1622 to STA 1610 via the first link if an explicit ACK procedure is used. Alternatively, relay 1611 may not transmit an ACK frame if an implicit ACK procedure is used.

In example 1600, after transmitting ACK frame 1622 via the first link, the first link may become busy such that relay 1611 may not be able to use the first link to forward the low latency data frame (comprised in PPDU 1621) to STA 1612. In such a case, relay 1611 may use the second link (e.g., Link-2) to transmit a PPDU 1623 (comprising the low latency data frame) to STA 1612. Relay 1611 may directly transmit PPDU 1623 to STA 1612 if no TXOP protection is used. Upon receiving PPDU 1623, STA 1612 may transmit an ACK frame 1624 to relay 1611 via the second link. As illustrated in FIG. 16, a relay switching from a first link to a second link in the case of a busy first link may reduce the transmission delay. However, in the case of a long duration (e.g., in the order of milliseconds) PPDU, the reception of PPDU 1623 may be completed after the transmission completion time as shown in FIG. 16.

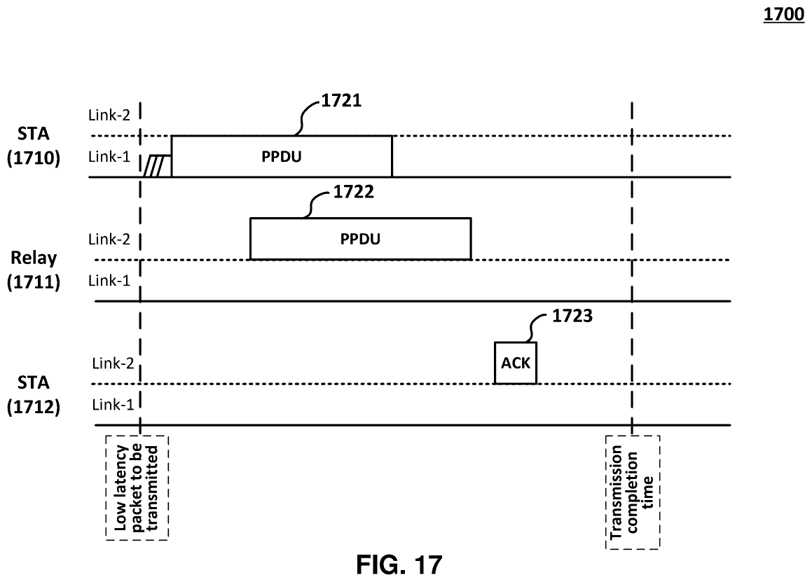

FIG. 17 is an example 1700 that illustrates an MLD relay transmitting via a first link while receiving via a second link. As shown in FIG. 17, example 1700 includes a relay 1711 and a plurality of STAs 1710 and 1712. STA 1710 may be a source STA, and STA 1712 may be a destination STA. Relay 1711 and STAs 1710 and 1712 may each comprise an AP MLD or a non-AP MLD capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In example 1700, STA 1710 may have a low latency data frame to transmit to STA 1712 via relay 1711 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 1710 may associate a counter with the transmission completion time. The transmission completion time counter may start with the initiation of the relaying procedure by STA. In another implementation, the transmission completion time counter may start with the transmission of the low latency data frame by STA 1710. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to an existing procedure, STA 1710 may directly transmit a PPDU 1721, comprising the low latency data frame, to relay 1711 via a first link, if no TXOP protection is used. In another example, TXOP protection may be supported by implementing an RTS-CTS exchange before the transmission of PPDU 1721. In an example, PPDU 1721 may comprise multiple MPDUs. In an example, PPDU 1721 may comprise a single MPDU. In the existing procedure, relay 1711 may be a designated relay between STA 1710 and 1712. That is, relay 1711 may be configured to decode PPDU 1721 received from STA 1710 and to forward its contents in a PPDU 1722 to STA 1712. In an example, relay 1711 may check PPDU 1721 for an indication of relaying and may perform the decode and forward operation based on the indication. In an example, relay 1711 may decode a portion of PPDU 1721, re-encode it, and transmit it in PPDU 1722 via the second link to STA 1712, while still receiving PPDU 1721 via the first link from STA 1710. When STA 1712 fully receives PPDU 1722 via the second link, STA 1712 may send an ACK frame 1723 to relay 1711 via the second link. As illustrated in FIG. 17, when a relay begins forwarding a low latency data frame to a destination STA via a second link while still receiving the low latency data frame via a first link, latency may be reduced and the low latency data frame may be received within the transmission completion time. This may be advantageous from a latency perspective, particularly when the low latency data frame is forwarded in a long duration PPDU. The improved latency is due to the relay not fully decoding the PPDU comprising the low latency data frame before relaying the low latency data frame to the destination STA.

One limitation of the existing approach is that the relaying operation may be performed only by a designated relay for relaying from a specific source STA to a specific destination STA, e.g., after detecting a relaying indication. This may be inadequate for future IEEE 802.11 radio environments in which STAs may be both destination STAs or relays for other destination STAs.

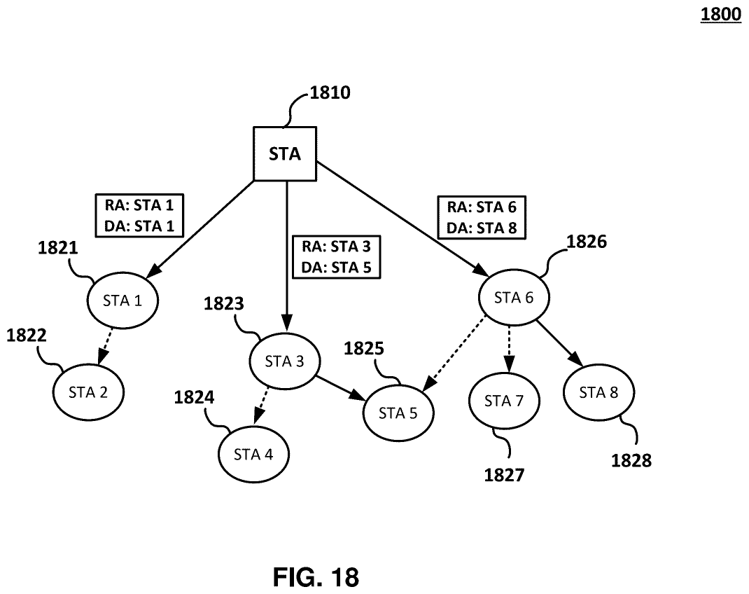

FIG. 18 is an example 1800 that illustrates a relay configuration. As shown in FIG. 18, example 1800 includes a plurality of STAs 1810 and 1821-1828. STAs 1810 and 1821-1828 may each comprise an AP MLD or a non-AP MLD capable of communicating over multiple links. STA 1810 may be a source STA. STAs 1821, 1823, and 1826 may be destination STAs or relays. STAs 1822, 1824, 1825, 1827, and 1828 may be destination STAs.

As shown in FIG. 18, in an example, STA 1821 may receive a data frame from STA 1810. The data frame may be comprised in a data unit (e.g., MPDU) of a PPDU. The data frame may be destined either to STA 1821 or to STA 1822 (i.e., a destination address of the data frame may be set either to an address of STA 1821 or to an address of STA 1822). When the data frame is destined to STA 1822, STA 1821 may serve as a relay to forward the data frame to STA 1822. In an example, both a receiver address (RA) and a destination address (DA) (e.g., in a medium access control (MAC) header) of the data frame indicate the address of STA 1821. Hence, STA 1821 does not relay the data frame after fully decoding and performing FCS control. In an example, STA 1823 may receive a data frame from STA 1810 destined either to itself or to STAs 1824 or 1825. In an example, an RA of the data frame may indicate an address of STA 1823 and a DA of the data frame may indicate an address of STA 1825. Hence, STA 1823 relays the data frame to STA 1825 after fully decoding and performing FCS control. In an example, STA 1826 may receive a data frame from STA 1810 destined either to itself or to STAs 1825, 1827, or 1828. In an example, an RA of the data frame may indicate an address of STA 1826 and a DA of the data frame may indicate an address of STA 1828. Hence, STA 1826 relays the data frame to STA 1828 after fully decoding and performing FCS control.

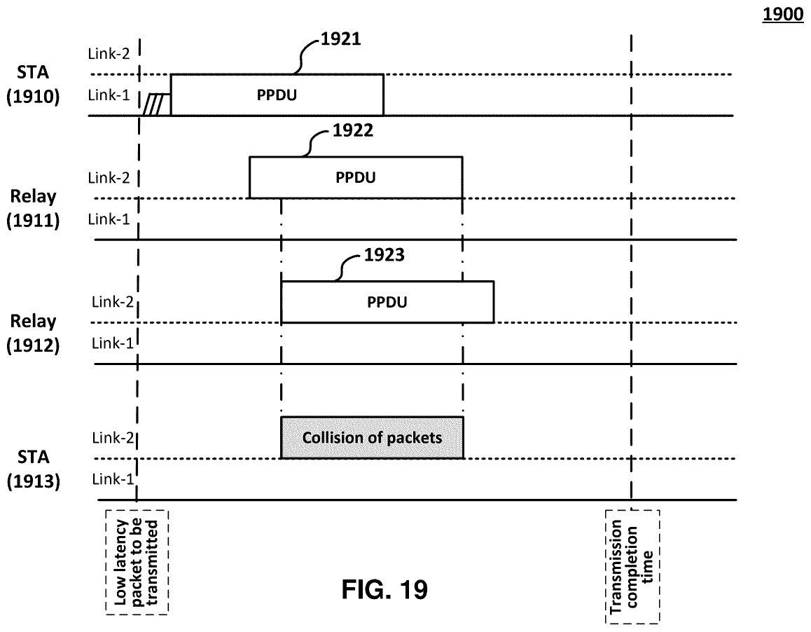

As shown in FIG. 18, in another example, STAs 1823 and 1826 may serve as relays for STA 1825. In such a case, with the existing procedure for low latency relaying described in FIG. 17, upon receiving a low latency data frame from STA 1810 and confirming for an indication of relaying in the PHY header of the PPDU, STA 1823 and STA 1826 may relay the same data frame without checking the RA and DA fields. As such, the destination STA (i.e., STA 1825) may receive data frames unsynchronized from STAs 1823 and 1826. This problem is further illustrated in FIG. 19 below.

FIG. 19 is an example 1900 that illustrates multiple MLD relays transmitting via a link while receiving via another link. As shown in FIG. 19, example 1900 includes a plurality of relays 1911 and 1912 and a plurality of STAs 1910 and 1913. STA 1910 may be a source STA, and STA 1913 may be a destination STA. Relay 1911 and relay 1912 may be STAs with relaying capabilities (i.e., not designated relays). In an example, relay 1911 and relay 1912 may receive data frames from STA 1910 destined to them. In an example, relay 1911 and relay 1912 may serve STA 1913 as relays. STAs 1910 and 1913 and relays 1911 and 1912 may each comprise an AP MLD or a non-AP MLD capable of communicating over multiple links.

In example 1900, STA 1910 may have a low latency data frame to transmit to STA 1913 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 1910 may associate a counter with the transmission completion time. The transmission completion time counter may start with the initiation of the relaying procedure by STA. In another implementation, the transmission completion time counter may start with the transmission of the low latency data frame by STA 1910. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

According to an existing procedure presented in FIG. 17, STA 1910 may directly transmit PPDU 1921, comprising the low latency data frame, via a first link, if no TXOP protection is used. In another example, TXOP protection may be supported by implementing an RTS-CTS exchange before the transmission of PPDU 1921. In an example, PPDU 1921 may comprise multiple MPDUs. In an example, PPDU 1921 may comprise a single MPDU. Upon receiving PPDU 1921, relay 1911 may check PPDU 1921 for an indication of relaying and may perform the decode and forward operation based on the indication. In an example, relay 1911 may decode a portion of PPDU 1921, re-encode it, and transmit it in PPDU 1922 via the second link, while still receiving PPDU 1921 via the first link from STA 1910. Similarly, upon receiving PPDU 1921, relay 1912 may check PPDU 1921 for an indication of relaying and may perform the decode and forward operation based on the indication. In an example, relay 1912 may decode a portion of PPDU 1921, re-encode it, and transmit it in PPDU 1923 via the second link, while still receiving PPDU 1921 via the first link from STA 1910.

As a result, both relays 1911 and 1912 relay the low latency data frame comprised in PPDU 1921 in respective PPDUs 1922 and 1923. However, as shown in FIG. 19, PPDU 1922 transmitted by relay 1911 and PPDU 1923 transmitted by relay 1912 may not be aligned in time. As PPDUs 1922 and 1923 are transmitted over the same link, PPDUs 1922 and PPDU 1923 may interfere with each other at STA 1913 and may not be received successfully by STA 1913. Hence, the reception of the low latency data frame may not be successful in the presence of multiple relays even though the existing procedure may allow the low latency data frame to be delivered to the destination STA before the transmission completion time.

Embodiments of the present disclosure, as further described below, address the above-described problems of the existing procedure. In one aspect, embodiments enable a STA with relay capabilities (as opposed to a designated relay) to determine whether it shall act as a relay to forward a low latency data frame without fully decoding the data frame. In an embodiment, the source STA may transmit this information in a first portion of the data frame to enable low latency transmission. In another aspect, embodiments enable a STA with relay capabilities to check the destination address of the data frame and update it in the forwarded low latency data frame for correct reception by the destination STA. In a further aspect, embodiments prevent multiple STAs with relay capabilities from acting as relays for the same data frame, eliminating potential interference at the destination STA.

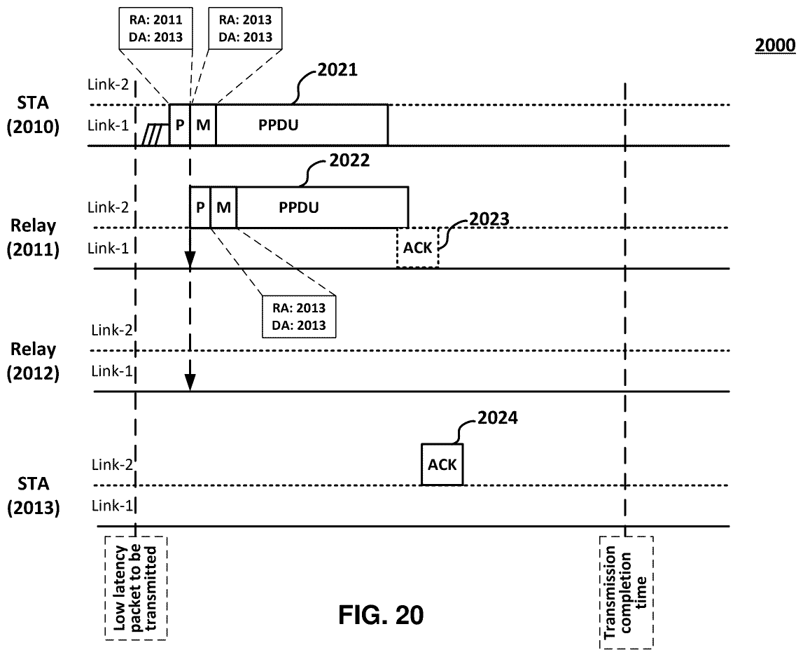

FIG. 20 is an example 2000 that illustrates a procedure which may be used to relay low latency data by an MLD relay. As shown in FIG. 20, example 2000 includes a plurality of relays 2011 and 2012 and a plurality of STAs 2010 and 2013. STA 2010 may be a source STA, and STA 2013 may be a destination STA. Relay 2011 and relay 2012 may be MLD relays. In an example, relay 2011 and relay 2012 may receive data frames from STA 2010 destined to them. In an example, relay 2011 and relay 2012 may serve as relays for STA 2013. STAs 2010 and 2013 and relays 2011 and 2012 may each comprise an AP MLD or a non-AP MLD capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In example 2000, STA 2010 may have a low latency data frame to transmit to STA 2013 via relay 2011 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 2010 may associate a counter with the transmission completion time. The transmission completion time counter may start with the initiation of the relaying procedure by STA. In another implementation, the transmission completion time counter may start with the transmission of the low latency data frame by STA 2010. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In an embodiment, to transmit a low latency data frame using a relay to a destination STA, STA 2010 may directly transmit a PPDU 2021, comprising the low latency data frame, to relay 2011 via a first link, if no TXOP protection is used. In another example, TXOP protection may be supported by implementing an RTS-CTS exchange before the transmission of PPDU 2021. In an example, PPDU 2021 may comprise multiple MPDUs. In an example, PPDU 2021 may comprise a single MPDU. In an example, PPDU 2021 may comprise a first portion indicating low latency relaying and comprising an address of relay 2011 as a first receiver address (RA) of PPDU 2021. As used herein, low latency relaying refers to a relaying approach in which the relay of a frame to a destination STA begins before the frame is fully received or fully decoded by the relaying STA. An indication of low latency relaying in a PPDU indicates to a receiving STA to use low latency relaying to relay one or more data frames comprised in the PPDU. In an example, the first portion may comprise a portion of a physical layer (PHY) header of PPDU 2021. The first RA in the PHY header may indicate to relay 2011 the address of the intended receiver of PPDU 2021. Hence, the first RA in the PHY header may be different than a second RA in a medium access control (MAC) header of a data unit (e.g., comprising the low latency data frame) comprised in PPDU 2021. In addition to the RA, the first portion may comprise an address of STA 2013 as a destination address (DA) of PPDU 2021. Based on the DA of PPDU 2021 being different than the first RA of PPDU 2021, the first portion may indicate low latency relaying for PPDU 2021.

In an example, PPDU 2021 may further comprise a second portion, where the second portion may comprise a portion of the PHY header of PPDU 2021. In another example, the second portion may comprise a portion of a MAC header of the data unit comprised in PPDU 2021. In an example, the second portion may comprise the second RA, where the second RA may be equal to the address of STA 2013 as a DA of the data unit comprised in PPDU 2021. In addition, PPDU 2021 may further comprise a frame body of a first medium access control (MAC) protocol data unit (MPDU).

Upon receiving the first portion of PPDU 2021, via the first link, from STA 2010, relay 2011 may process the first portion. Based on the first portion of PPDU 2021 indicating low latency relaying, where the indication is inferred from the DA being different than the first RA in the PHY header and the first portion of PPDU 2021 comprising the address of relay 2011 as the first RA of PPDU 2021, relay 2011 may decode and forward the second portion of the PPDU 2021 for transmission in PPDU 2022 via a second link to STA 2013. As explained above, the second portion of PPDU 2021 may comprise a second RA, where the second RA may be equal to the address of STA 2013 as a DA of the low latency data frame comprised in PPDU 2021. As such, forwarding the second portion of PPDU 2021 for transmission in PPDU 2022 does not comprise modifying the second portion. Accordingly, STA 2013 may successfully decode the RA and DA values addressed to itself in PPDU 2022. In an example, relay 2011 may further decode and forward the second portion of PPDU 2021 for transmission in PPDU 2022 via the second link to STA 2013, while receiving PPDU 2021 via the first link from STA 2010. STA 2010 may further transmit a PHY header of PPDU 2022 before transmitting the second portion of PPDU 2021 in PPDU 2022.

In an example, relay 2011 may further decode and forward a third portion of PPDU 2021 for transmission in PPDU 2022 via the second link to STA 2013, after transmitting the second portion of PPDU 2021 in PPDU 2022. In an example, the third portion of PPDU 2021 may be a portion of a frame body of a first MPDU of PPDU 2021. The first MPDU may comprise a portion of the low latency data frame. In an example, the first MPDU may be longer than 1 ms. The advantages of multi-link relaying as described above are particularly advantageous in such a case.

While relay 2011 may decode and forward portions of PPDU 2021 before it fully receives PPDU 2021, relay 2011 may perform a frame check sequence (FCS) control when PPDU 2021 is fully received. After a successful FCS control of PPDU 2021, relay 2011 may transmit ACK frame 2023 to STA 2010 via the first link. In another example, after a failed FCS control of PPDU 2021, relay 2011 may not transmit an ACK frame. Upon receiving PPDU 2022 successfully, STA 2013 may transmit an ACK frame 2024 to relay 2011 via the second link. In an example, ACK frames 2023 and 2024 may be block ACK frames.

In an example, in addition to relay 2011, relay 2012 may receive the first portion of the PPDU 2021, via the first link from STA 2010, and may process it. Based on the first portion of PPDU 2021 comprising the address of relay 2011 as the first RA of PPDU 2021, relay 2012 may ignore PPDU 2021 despite the indication of relaying. The potential for interference due to both relays 2011 and 2012 attempting to relay PPDU 2021 is therefore eliminated. With the proposed procedure and signaling, low latency relaying may successfully be implemented in the presence of multiple STAs that may function as STAs or relays.

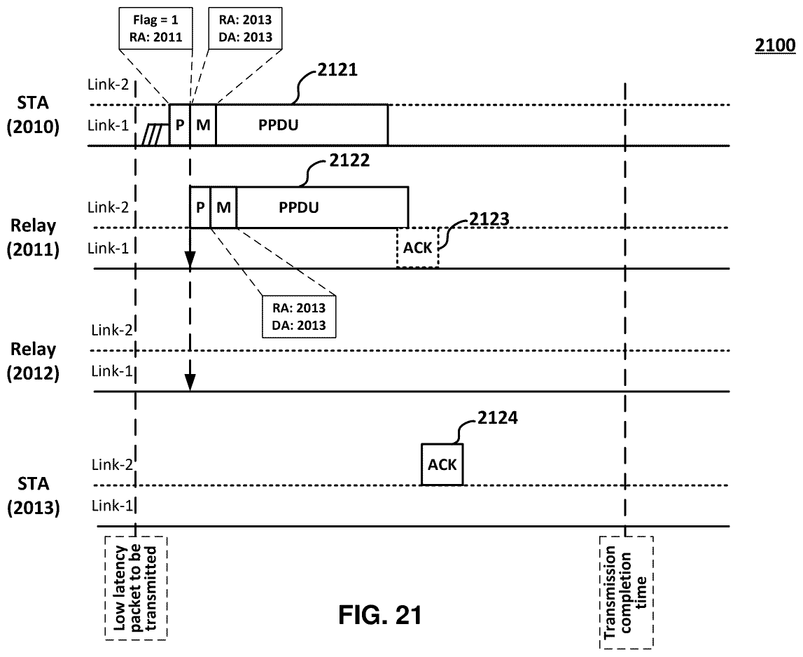

FIG. 21 is an example 2100 that illustrates another procedure which may be used to relay low latency data by an MLD relay. As shown in FIG. 21, example 2100 includes a plurality of relays 2011 and 2012, and a plurality of STAs 2010 and 2013. STA 2010 may be a source STA, and STA 2013 may be a destination STA. Relay 2011 and relay 2012 may be MLD relays. In an example, relay 2011 and relay 2012 may receive data frames from STA 2010 destined to them. In an example, relay 2011 and relay 2012 may serve as relays for STA 2013. STAs 2010 and 2013 and relays 2011 and 2012 may each comprise an AP MLD or a non-AP MLD capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHZ band, the 5 GHz band, the 6 GHz band, or a future to be defined band, with the second link being different from the first link.

In example 2100, STA 2010 may have a low latency data frame to transmit to STA 2013 via relay 2011 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 2010 may associate a counter with the transmission completion time. The transmission completion time counter may start with the initiation of the relaying procedure by STA. In another implementation, the transmission completion time counter may start with the transmission of the low latency data frame by STA 2010. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In an embodiment, to transmit a low latency data frame using a relay to a destination STA, STA 2010 may directly transmit a PPDU 2121, comprising the low latency data frame, to relay 2011 via a first link, if no TXOP protection is used. In another example, TXOP protection may be supported by implementing an RTS-CTS exchange before the transmission of PPDU 2121. In an example, PPDU 2121 may comprise multiple MPDUs. In an example, PPDU 2121 may comprise a single MPDU. In an example, PPDU 2121 may comprise a first portion indicating low latency relaying and comprising an address of relay 2011 as a first receiver address (RA) of PPDU 2121. In an example, the first portion may comprise a portion of a physical layer (PHY) header. The first RA in the PHY header may indicate to relay 2011 the address of the intended receiver of PPDU 2021. Hence, the first RA in the PHY header may be different than a second RA in a MAC header of a data unit (e.g., comprising the low latency data frame) comprised in PPDU 2121. In an embodiment, the first portion comprises an indication of low latency relaying. In an embodiment, the indication of low latency relaying may comprise a one-bit flag.

In an example, PPDU 2121 may further comprise a second portion, where the second portion may comprise a portion of the PHY header of PPDU 2021. In another example, the second portion may comprise a portion of a MAC header of the data unit comprised in PPDU 2121. In an example, the second portion may comprise the second RA, where the second RA may be equal to the address of STA 2013 as a DA of the data unit comprised in PPDU 2121. In addition, PPDU 2121 may further comprise a frame body of a first medium access control (MAC) protocol data unit (MPDU).

Upon receiving the first portion of PPDU 2121, via the first link, from STA 2010, relay 2011 may process the first portion. Based on the first portion of PPDU 2121 indicating low latency relaying, where the indication is inferred from the one-bit flag and the first portion of PPDU 2121 comprising the address of relay 2011 as the first RA of PPDU 2121, relay 2011 may decode and forward the second portion of the PPDU 2121 for transmission in PPDU 2122 via a second link to STA 2013. As explained above, the second portion of PPDU 2121 may comprise a second RA, where the second RA may be equal to the address of STA 2013 as a DA of the low latency data frame comprised in PPDU 2121. As such, forwarding the second portion of PPDU 2121 for transmission in PPDU 2122 does not comprise modifying the second portion. Accordingly, STA 2013 may successfully decode the RA and DA values addressed to itself in PPDU 2122. In an example, relay 2011 may further decode and forward the second portion of PPDU 2121 for transmission in PPDU 2122 via the second link to STA 2013, while receiving PPDU 2121 via the first link from STA 2010. STA 2010 may further transmit a PHY header of PPDU 2122 before transmitting the second portion of PPDU 2121 in PPDU 2122.

In an example, relay 2011 may further decode and forward a third portion of PPDU 2121 for transmission in PPDU 2122 via the second link to STA 2013, after transmitting the second portion of PPDU 2121 in PPDU 2122. In an example, the third portion of PPDU 2121 may be a portion of a frame body of a first MPDU of PPDU 2121. The first MPDU may comprise a portion of the low latency data frame. In an example, the first MPDU may be longer than 1 ms. The advantages of multi-link relaying as described above are particularly advantageous in such a case.

While relay 2011 may decode and forward portions of PPDU 2121 before it fully receives PPDU 2121, relay 2011 may perform a frame check sequence (FCS) control when PPDU 2121 is fully received. After a successful FCS control of PPDU 2121, relay 2011 may transmit ACK frame 2123 to STA 2010 via the first link. In another example, after a failed FCS control of PPDU 2121, relay 2011 may not transmit an ACK frame. Upon receiving PPDU 2122 successfully, STA 2013 may transmit an ACK frame 2124 to relay 2011 via the second link. In an example, ACK frames 2123 and 2124 may be block ACK frames.

In an example, in addition to relay 2011, relay 2012 may receive the first portion of the PPDU 2121, via the first link from STA 2010, and may process it. Based on the first portion of PPDU 2121 comprising the address of relay 2011 as the first RA of PPDU 2121, relay 2012 may ignore PPDU 2121 despite the indication of relaying. The potential for interference due to both relays 2011 and 2012 attempting to relay PPDU 2021 is therefore eliminated. With the proposed procedure and signaling, low latency relaying may successfully be implemented in the presence of multiple STAs that may function as STAs or relays.

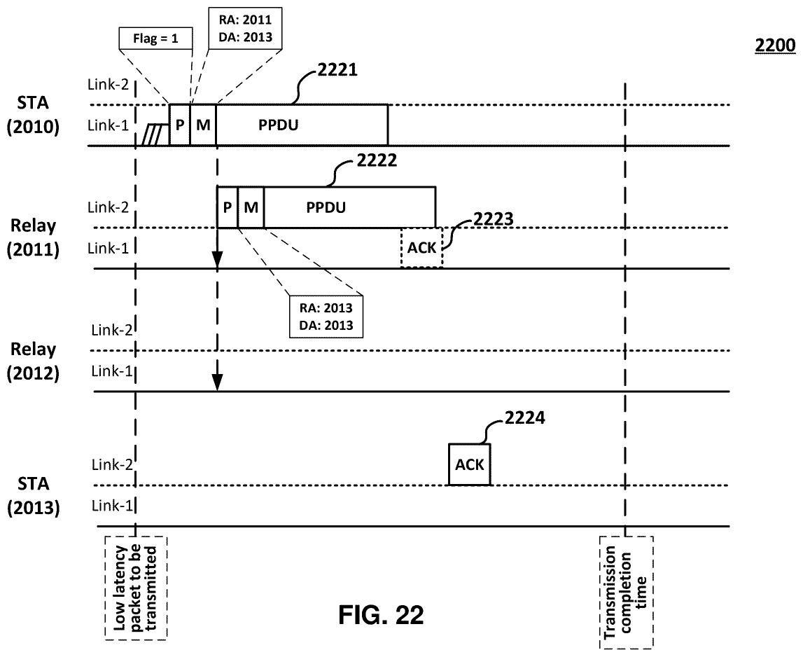

FIG. 22 is an example 2200 that illustrates another procedure which may be used to relay low latency data by an MLD relay. As shown in FIG. 22, example 2200 includes a plurality of relays 2011 and 2012, and a plurality of STAs 2010 and 2013. STA 2010 may be a source STA, and STA 2013 may be a destination STA. Relay 2011 and relay 2012 may be MLD relays. In an example, relay 2011 and relay 2012 may receive data frames from STA 2010 destined to them. In an example, relay 2011 and relay 2012 may serve as relays for STA 2013. STAs 2010 and 2013 and relays 2011 and 2012 may each comprise an AP MLD or a non-AP MLD capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In example 2200, STA 2010 may have a low latency data frame to transmit to STA 2013 via relay 2011 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 2010 may associate a counter with the transmission completion time. The transmission completion time counter may start with the initiation of the relaying procedure by STA. In another implementation, the transmission completion time counter may start with the transmission of the low latency data frame by STA 2010. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In an embodiment, to transmit a low latency data frame using a relay to a destination STA, STA 2010 may directly transmit a PPDU 2221, comprising the low latency data frame, to relay 2011 via a first link, if no TXOP protection is used. In another example, TXOP protection may be supported by implementing an RTS-CTS exchange before the transmission of PPDU 2221. In an example, PPDU 2221 may comprise multiple MPDUs. In an example, PPDU 2221 may comprise a single MPDU. In an example, PPDU 2221 may comprise a first portion indicating low latency relaying and comprising an address of relay 2011 as a receiver address (RA) of PPDU 2221. In an example, the first portion may comprise a portion of a physical layer (PHY) header and a portion of a medium access control (MAC) header comprised in PPDU 2221. In an example, the first portion may comprise an indication of low latency relaying in the PHY header. The indication may comprise a one-bit flag. In an embodiment, the RA of PPDU 2221 may be the RA of a data unit comprised in PPDU 2221 and may be comprised in the MAC header of the data unit.

In an example, PPDU 2221 may further comprise a second portion, where the second portion may comprise a portion of the MAC header of the data unit comprised in PPDU 2221. In an example, the second portion may comprise the address of STA 2013 as a DA of the data unit comprised in PPDU 2221. In an example, the DA of the data unit comprised in PPDU 2221 may not be equal to the RA of the data unit comprised in PPDU 2221. In addition, PPDU 2221 may further comprise a third portion, where the third portion may further comprise a portion a frame body of a first medium access control (MAC) protocol data unit (MPDU).

Upon receiving the first portion of PPDU 2221, via the first link, from STA 2010, relay 2011 may process the first portion. Based on the first portion of PPDU 2221 indicating low latency relaying, where the indication is inferred from the one-bit flag and the first portion of PPDU 2221 comprising the address of relay 2011 as the RA of the data unit comprised in PPDU 2221, relay 2011 may decode a second portion of PPDU 2221 to obtain a DA of the data unit comprised in PPDU 2221. In an example, not having the DA of the data unit comprised in PPDU 2221 equal to the RA of the data unit comprised in PPDU 2221, relay 2011 may set the DA of the data unit comprised in PPDU 2221 as an RA of the data unit comprised in PPDU 2222. Accordingly, STA 2013 may successfully decode the RA and DA values addressed to itself in PPDU 2222.

In an example, relay 2011 may forward a third portion of PPDU 2221 for transmission in PPDU 2222 via a second link to STA 2013 corresponding to the DA. In an example, the third portion of PPDU 2221 may comprise a portion of a frame body of a first MPDU of the PPDU 2221. The first MPDU may comprise a portion of the low latency data frame. In an example, the first MPDU may be longer than 1 ms. The advantages of multi-link relaying as described above are particularly advantageous in such a case. In an example, relay 2011 may further forward the third portion of PPDU 2221 for transmission in PPDU 2222 via the second link to STA 2013, while receiving PPDU 2221 via the first link from STA 2010. STA 2010 may further transmit a PHY header of PPDU 2222 before transmitting the third portion of PPDU 2221 in PPDU 2222.

While relay 2011 may decode and forward portions of PPDU 2221 before it fully receives PPDU 2221, relay 2011 may perform a frame check sequence (FCS) control when PPDU 2221 is fully received. After a successful FCS control of PPDU 2221, relay 2011 may transmit ACK frame 2223 to STA 2010 via the first link. In another example, after a failed FCS control of PPDU 2221, relay 2011 may not transmit an ACK frame. Upon receiving PPDU 2222 successfully, STA 2013 may transmit an ACK frame 2224 to relay 2011 via the second link. In an example, ACK frames 2223 and 2224 may be block ACK frames.

In an example, in addition to relay 2011, relay 2012 may receive the first portion of the PPDU 2221, via the first link from STA 2010, and may process it. Based on the first portion of PPDU 2221 comprising the address of relay 2011 as the RA of PPDU 2221, relay 2012 may ignore PPDU 2221 despite the indication of relaying. The potential for interference due to both relays 2011 and 2012 attempting to relay PPDU 2021 is therefore eliminated. With the proposed procedure and signaling, low latency relaying may successfully be implemented in the presence of multiple STAs that may function as STAs or relays.

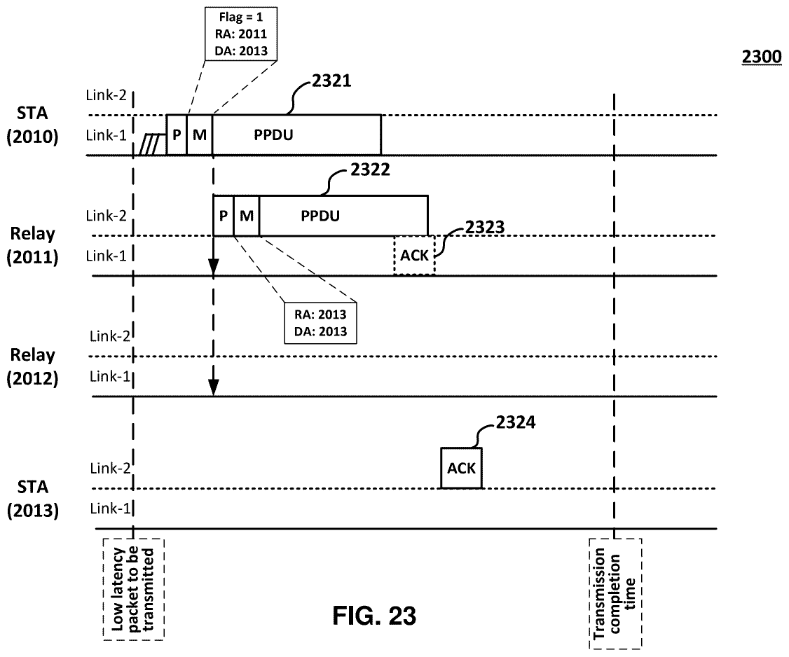

FIG. 23 is an example 2300 that illustrates another procedure which may be used to relay low latency data by an MLD relay. As shown in FIG. 23, example 2300 includes a plurality of relays 2011 and 2012, and a plurality of STAs 2010 and 2013. STA 2010 may be a source STA, and STA 2013 may be a destination STA. Relay 2011 and relay 2012 may be MLD relays. In an example, relay 2011 and relay 2012 may receive data frames from STA 2010 destined to them. In an example, relay 2011 and relay 2012 may serve as relays for STA 2013. STAs 2010 and 2013 and relays 2011 and 2012 may each comprise an AP MLD or a non-AP MLD capable of communicating over multiple links, e.g., a first link and a second link. In an example, the first link may comprise one of a 2.4 GHz band, a 5 GHZ band, a 6 GHz band, or a future to be defined band. Similarly, the second link may comprise one of the 2.4 GHz band, the 5 GHz band, the 6 GHz band, or a future to be defined band, with the second link being different from the first link.

In example 2300, STA 2010 may have a low latency data frame to transmit to STA 2013 via relay 2011 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 2010 may associate a counter with the transmission completion time. The transmission completion time counter may start with the initiation of the relaying procedure by STA. In another implementation, the transmission completion time counter may start with the transmission of the low latency data frame by STA 2010. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In an embodiment, to transmit a low latency data frame using a relay to a destination STA, STA 2010 may directly transmit a PPDU 2321, comprising the low latency data frame, to relay 2011 via a first link, if no TXOP protection is used. In another example, TXOP protection may be supported by implementing an RTS-CTS exchange before the transmission of PPDU 2321. In an example, PPDU 2321 may comprise multiple MPDUs. In an example, PPDU 2321 may comprise a single MPDU. In an example, PPDU 2321 may comprise a first portion indicating low latency relaying and comprising an address of relay 2011 as a receiver address (RA) of PPDU 2321. In an example, the first portion may comprise a portion of a physical layer (PHY) header of PPDU 2321 and a portion of a medium access control (MAC) header of the low latency data frame comprised in PPDU 2321. In an example, the first portion may comprise an indication of low latency relaying in the MAC header. The indication may comprise a one-bit flag. In an embodiment, the RA of PPDU 2321 may be the RA of a data unit comprised in PPDU 2321 and may be comprised in the MAC header of the data unit.

In an example, PPDU 2321 may further comprise a second portion, where the second portion may comprise a portion of the MAC header comprised in PPDU 2321. In an example, the second portion may comprise the address of STA 2013 as a DA of the data unit comprised in PPDU 2321. In an example, the DA of the data unit comprised in PPDU 2321 may not be equal to the RA of the data unit comprised in PPDU 2321. In addition, PPDU 2321 may further comprise a third portion, where the third portion may further comprise a frame body of a first medium access control (MAC) protocol data unit (MPDU).

Upon receiving the first portion of PPDU 2321, via the first link from STA 2010, relay 2011 may process the first portion. Based on the first portion of PPDU 2321 indicating low latency relaying, where the indication is inferred from the one-bit flag, and the first portion of PPDU 2321 comprising the address of relay 2011 as the RA of the data unit comprised in PPDU 2321, relay 2011 may decode a second portion of PPDU 2321 to obtain a DA of the data unit comprised in PPDU 2321. In an example, not having the DA of the data unit comprised in PPDU 2321 equal to the RA of the data unit comprised in PPDU 2321, relay 2011 may set the DA of the data unit comprised in PPDU 2321 as an RA of the data unit comprised in PPDU 2322. Accordingly, STA 2013 may successfully decode the RA and DA values addressed to itself in PPDU 2322.

In an example, relay 2011 may forward a third portion of PPDU 2321 for transmission in PPDU 2322 via a second link to STA 2013 corresponding to the DA. In an example, the third portion of PPDU 2321 may comprise a portion of a frame body of a first MPDU of the first PPDU. The first MPDU may comprise a portion of the low latency data frame. In an example, the first MPDU may be longer than 1 ms. The advantages of multi-link relaying as described above are particularly advantageous in such a case. In an example, relay 2011 may further forward the third portion of PPDU 2321 for transmission in PPDU 2322 via the second link to STA 2013, while receiving PPDU 2321 via the first link from STA 2010. STA 2010 may further transmit a PHY header of PPDU 2322 before transmitting the third portion of PPDU 2321 in PPDU 2322.

While relay 2011 may decode and forward portions of PPDU 2321 before it fully receives PPDU 2321, relay 2011 may perform a frame check sequence (FCS) control when PPDU 2321 is fully received. After a successful FCS control of PPDU 2321, relay 2011 may transmit ACK frame 2323 to STA 2010 via the first link. In another example, after a failed FCS control of PPDU 2321, relay 2011 may not transmit an ACK frame. Upon receiving PPDU 2322 successfully, STA 2013 may transmit an ACK frame 2324 to relay 2011 via the second link. In an example, ACK frames 2323 and 2324 may be block ACK frames.

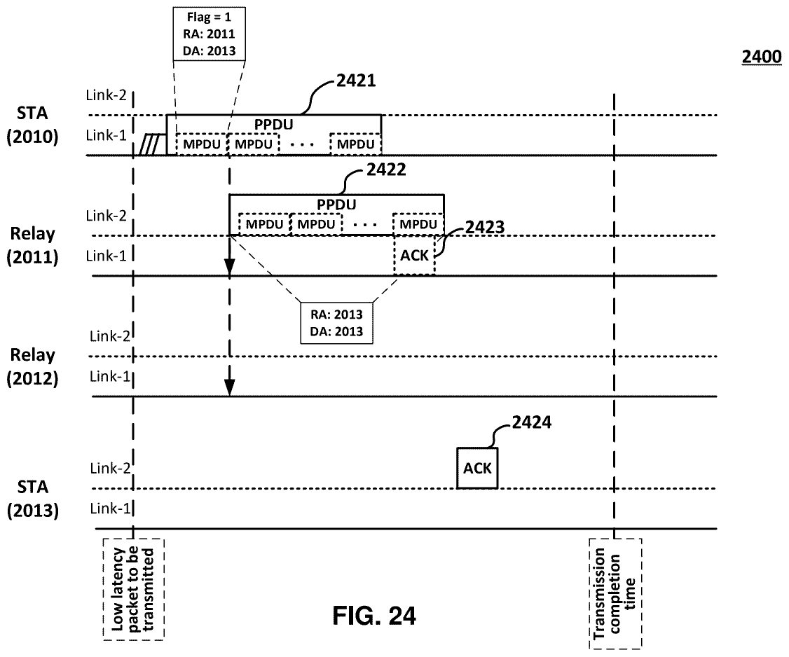

In an example, in addition to relay 2011, relay 2012 may receive the first portion of the PPDU 2321, via the first link from STA 2010, and may process it. Based on the first portion of PPDU 2321 comprising the address of relay 2011 as the RA of PPDU 2321, relay 2012 may ignore PPDU 2321 despite the indication of relaying. The potential for interference due to both relays 2011 and 2012 attempting to relay PPDU 2021 is therefore eliminated. With the proposed procedure and signaling, low latency relaying may successfully be implemented in the presence of multiple STAs that may function as STAs or relays. As illustrated in the embodiments of FIGS. 20-23, the relay may start forwarding the first PPDU, as soon as it determines that it is itself the relay of the first PPDU, and after making changes to the RA for the second PPDU, if necessary. In case the first PPDU includes a single MPDU, the relay may perform FCS control for the first PPDU at the end of the MPDU. In case the first PPDU includes multiple MPDUs, the relay may perform FCS control for the first MPDU before the transmission of the second PPDU to increase reliability as illustrated in FIG. 24.

FIG. 24 is an example 2400 that illustrates another procedure which may be used to relay low latency data by an MLD relay. As shown in FIG. 24, example 2400 includes a plurality of relays 2011 and 2012, and a plurality of STAs 2010 and 2013. STA 2010 may be a source STA, and STA 2013 may be a destination STA. Relay 2011 and relay 2012 may be MLD relays. In an example, relay 2011 and relay 2012 may receive data frames from STA 2010 destined to them. In an example, relay 2011 and relay 2012 may serve as relays for STA 2013. STAs 2010 and 2013 and relays 2011 and 2012 may each comprise an AP MLD or a non-AP MLD capable of communicating over multiple links, e.g., a first link and a second link. In an example, the first link may comprise one of a 2.4 GHz band, a 5 GHZ band, a 6 GHz band, or a future to be defined band. Similarly, the second link may comprise one of the 2.4 GHZ band, the 5 GHz band, the 6 GHz band, or a future to be defined band, with the second link being different from the first link.

In example 2400, STA 2010 may have a low latency data frame to transmit to STA 2013 via relay 2011 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 2010 may associate a counter with the transmission completion time. The transmission completion time counter may start with the initiation of the relaying procedure by STA. In another implementation, the transmission completion time counter may start with the transmission of the low latency data frame by STA 2010. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In an embodiment, to transmit a low latency data frame using a relay to a destination STA, STA 2010 may directly transmit a PPDU 2421, comprising the low latency data frame, to relay 2011 via a first link, if no TXOP protection is used. In another example, TXOP protection may be supported by implementing an RTS-CTS exchange before the transmission of PPDU 2421. In an example, PPDU 2421 may comprise multiple MPDUs. In an example, PPDU 2421 may comprise a first portion indicating: low latency relaying, an address of relay 2011 as an RA for all data units of PPDU 2421, and/or an address of STA 2013 as a DA for all data units of PPDU 2421. In an embodiment, the first portion may comprise an indication of: low latency relaying, that the receiver address is the same for all data units of the first PPDU, and that the destination address is the same for all data units of the first PPDU. In an example, the indication of low latency relaying, that the receiver address is the same for all data units of the first PPDU, and that the destination address is the same for all data units of the first PPDU comprises a one-bit flag. In an example, the first portion may comprise a portion of a first data unit of PPDU 2421. In an example, the first portion may be in a physical layer (PHY) header of PPDU 2421 or in a medium access control (MAC) header comprised in PPDU 2421. In another example, the first portion may be in a medium access control (MAC) header comprised in PPDU 2421.

In an example, PPDU 2421 may further comprise a second portion, where the second portion may comprise a second data unit of PPDU 2421. In an example, the first data unit may comprise a first medium access control (MAC) protocol data unit (MPDU) of PPDU 2421. In an example, the second data unit may comprise a second MPDU of PPDU 2421.

Upon receiving the first portion of PPDU 2421, via the first link, from STA 2010, relay 2011 may process the first portion. Based on the first portion of PPDU 2421 indicating low latency relaying, an address of relay 2011 as an RA for all data units of PPDU 2421, and an address of STA 2013 as a DA for all data units of PPDU 2421, the relay 2011 may decode and forward a second portion of PPDU 2421 for transmission in PPDU 2422 via a second link to STA 2013. In an example, relay 2011 may control the FCS of the first data unit of the first PPDU, and upon successful FCS control, relay 2011 may decode and forward the second portion of PPDU 2421. In an example, where RA and DA are different, the relay may set the DA of PPDU 2421 as an RA in a MAC header of at least one data unit of PPDU 2422. In another example, relay 2011 may set the DA of PPDU 2421 as an RA in MAC headers of all data units of PPDU 2422.

In an example, relay 2011 may further forward the first portion of PPDU 2421 for transmission in PPDU 2422 via the second link to STA 2013, while receiving the second portion of PPDU 2422 via the first link from STA 2010, where the first portion may comprise the first data unit of PPDU 2421. Before forwarding the first data unit of PPDU 2421, relay 2011 may perform an FCS control. After a successful FCS control of the first data unit of PPDU 2421, relay 2011 may forward the first data unit of PPDU 2421 for transmission in PPDU 2422. In another example, after a failed FCS control of the first data unit of PPDU 2421, relay 2011 may not forward the first data unit of PPDU 2421. In another example, after a successful control of FCSs of all data units of PPDU 2421, relay 2011 may transmit ACK frame 2423 to STA 2010 via the first link. In another example, after a failed control of FCSs for any of data units of PPDU 2421, relay 2011 may not transmit an ACK frame. Upon receiving PPDU 2422 successfully, STA 2013 may transmit ACK frame 2424 to relay 2011 via the second link. In an example, ACK frames 2423 and 2424 may be block ACK frames.

In an example, in addition to relay 2011, relay 2012 may receive the first portion of the PPDU 2421, via the first link from STA 2010, and may process it. Based on the first portion of PPDU 2421 comprising the address of relay 2011 as the RA of PPDU 2421, relay 2012 may ignore PPDU 2421 despite the indication of relaying. The potential for interference due to both relays 2011 and 2012 attempting to relay PPDU 2021 is therefore eliminated. With the proposed procedure and signaling, low latency relaying may successfully be implemented in the presence of multiple STAs that may function as STAs or relays. As illustrated in FIG. 24, in case multiple MPDUs are present in a PPDU, reliability may be increased by performing FCS before forwarding each MPDU in a second PPDU.

As would be understood by a person of skill in the art based on the teachings herein, all the embodiments of FIGS. 20-24 may further comprise TXOP protection while relaying. Accordingly, TXOP protection may be supported by implementing an RTS-CTS exchange before the transmission of data frames between the source STA and the relay and between the relay and the destination STA.

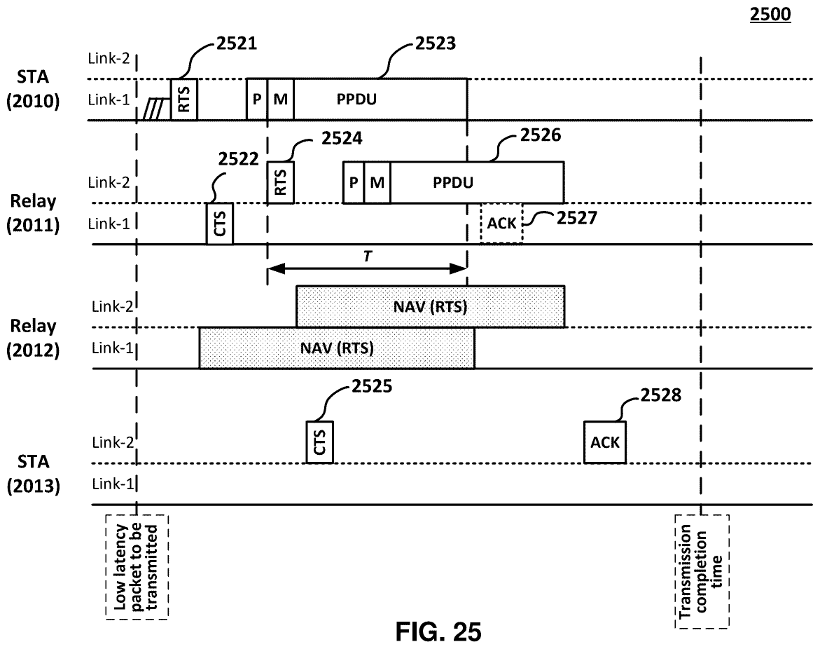

FIG. 25 is an example 2500 that illustrates a procedure for protecting a TXOP prior to performing low latency relaying during the TXOP. As shown in FIG. 25, example 2500 includes a plurality of relays 2011 and 2012, and a plurality of STAs 2010 and 2013. STA 2010 may be a source STA, and STA 2013 may be a destination STA. Relay 2011 and relay 2012 may be MLD relays. In an example, relay 2011 and relay 2012 may receive data frames from STA 2010 destined to them. In an example, relay 2011 and relay 2012 may serve as relays for STA 2013. STAs 2010 and 2013, and relays 2011 and 2012 may each comprise an AP MLD or a non-AP MLD capable of communicating over multiple links, e.g., a first link and a second link. In an example, the first link may comprise one of a 2.4 GHz band, a 5 GHz band, a 6 GHz band, or a future to be defined band. Similarly, the second link may comprise one of the 2.4 GHz band, the 5 GHz band, the 6 GHz band, or a future to be defined band, with the second link being different from the first link.

In example 2500, STA 2010 may have a low latency data frame to transmit to STA 2013 via relay 2011 within a transmission completion time. A low latency data frame may be a data frame that comprises one or more MPDUs having TIDs associated with one or more predetermined traffic categories or traffic streams (e.g., latency sensitive traffic categories or traffic streams). In an implementation, STA 2010 may associate a counter with the transmission completion time. The transmission completion time counter may start with the initiation of the relaying procedure by STA. In another implementation, the transmission completion time counter may start with the transmission of the low latency data frame by STA 2010. In an implementation, successful transmission of a low latency data frame may require acknowledgement of the low latency data frame by the destination STA before the transmission completion time counter expires. In an implementation, the transmission completion time may refer to the amount of time required for the low latency data frame to be delivered to the destination STA. The transmission completion time may be different for different low latency data frames.

In an embodiment, before transmitting a PPDU 2523, comprising the low latency data frame, via relay 2011 to STA 2013, STA 2010 may transmit an RTS frame 2521 to relay 2011 via the first link if TXOP protection is desired. In an example, STA 2010 may start the transmission completion time counter associated with PPDU 2523 on transmitting RTS frame 2521. On hearing RTS frame 2521 via the first link, relay 2012 may set its NAV for the first link (based on the duration/ID field of RTS frame 2521).

In an example, relay 2011 may transmit a CTS frame 2522 to STA 2010 in response to RTS frame 2521 via the first link, if its NAV indicates idle. On hearing CTS frame 2522 via the first link, relay 2012 may update its NAV for the first link (based on the duration field of CTS frame 2522). Typically, the duration/ID field of an RTS frame and the duration field of a responsive CTS frame are set to equal values; hence, a STA or a relay that hears a responsive CTS frame after hearing an RTS frame does not change the value of its NAV set upon hearing the RTS frame.

After receiving CTS frame 2522 over the first link, STA 2010 may transmit PPDU 2523, comprising the low latency data frame, to relay 2011 via the first link. In an example, PPDU 2523 may comprise multiple MPDUs. In an example, PPDU 2523 may comprise a single MPDU. In an example, PPDU 2523 may comprise a first portion indicating low latency relaying and comprising an address of relay 2011 as a receiver address (RA) of PPDU 2523 (or as RA for one or more data units of PPDU 2523) as given in the embodiments of FIGS. 20-24. Depending on the embodiment of the proposed procedures (cf. FIGS. 20-24), relay 2011 may be ready to forward a second portion of PPDU 2523 for transmission in PPDU 2526.

In order to protect PPDU 2526, relay 2011 may transmit an RTS frame 2524 to STA 2013 via the second link. In an example, relay 2011 may transmit RTS frame 2524 after decoding the PHY header of PPDU 2523. In an example, relay 2011 may transmit RTS frame 2524 after decoding the MAC header of PPDU 2523. In an example, relay 2011 may transmit RTS frame 2524 after a successful FCS control for the first MPDU of PPDU 2523. In an example, relay 2011 may transmit RTS frame 2524 any time within T-units of time after the PHY header decoding, where T-units of time may start with the decoding of the PHY header and end with the decoding of a last portion of PPDU 2523. TXOP protected low latency relaying would be beneficial in terms of low latency relaying if only RTS frame 2524 is transmitted within T-units of time. On hearing RTS frame 2524 via the second link, relay 2012 may set its NAV for the second link (based on the duration/ID field of RTS frame 2524).

In an example, STA 2013 may transmit a CTS frame 2525 to relay 2011 in response to RTS frame 2524 via the second link, if its NAV indicates idle. On hearing CTS frame 2525 via the second link, relay 2012 may update its NAV for the second link (based on the duration field of CTS frame 2525). Typically, the duration/ID field of an RTS frame and the duration field of a responsive CTS frame are set to equal values; hence, a STA or a relay that hears a responsive CTS frame after hearing an RTS frame does not change the value of its NAV set upon hearing the RTS frame.

After receiving CTS frame 2525 over the second link, relay 2011 may transmit PPDU 2526 to STA 2013 via the second link. While relay 2011 may decode and forward portions of PPDU 2523 before it fully receives PPDU 2523, it may perform a frame check sequence (FCS) control. After a successful FCS control of PPDU 2523, relay 2011 may transmit ACK frame 2527 to STA 2010 via the first link. In another example, after a failed FCS control of PPDU 2523, relay 2011 may not transmit an ACK frame. Upon receiving PPDU 2526 successfully, STA 2013 may transmit ACK frame 2528 to relay 2011 via the second link. In an example, ACK frames 2527 and 2528 may be block ACK frames.

In an example, in addition to relay 2011, relay 2012 may receive the first portion of the PPDU 2523, via the first link from STA 2010, and may process it. Having its NAV set to a non-zero value does not stop relay 2012 from processing PPDU 2523. Based on the first portion of PPDU 2523 comprising the address of relay 2011 as the RA of PPDU 2523, relay 2012 may ignore PPDU 2523 despite the indication of relaying. The potential for interference due to both relays 2011 and 2012 attempting to relay PPDU 2021 is therefore eliminated. With the proposed procedure and signaling that includes TXOP protection, low latency relaying may still be achieved with increased reliability in the presence of multiple STAs that may function as STAs or relays.

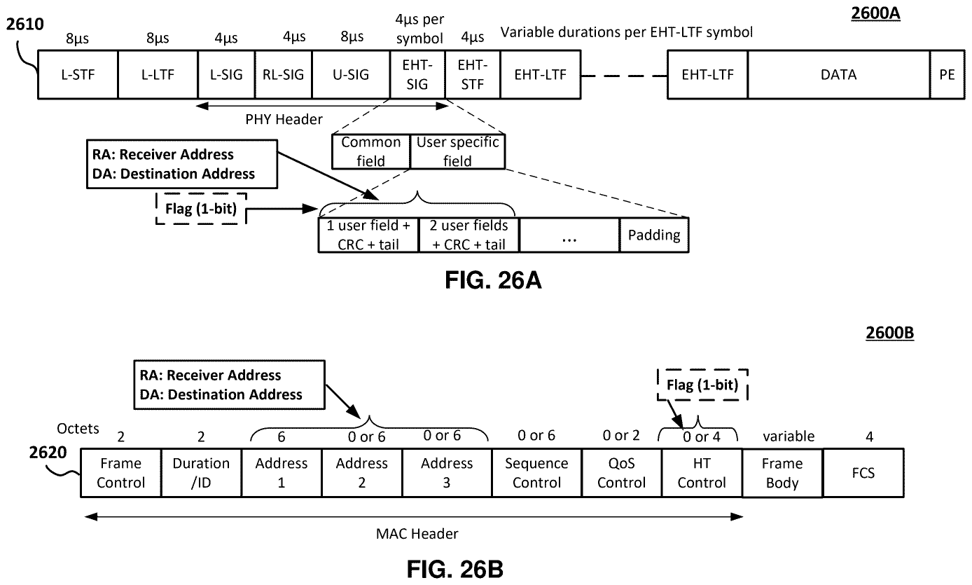

FIGS. 26A-26B illustrate examples 2600A and 2600B of fields which may be used in embodiments of the present disclosure.

In an embodiment, as described above in FIG. 20, the PPDU from the source STA (e.g., PPDU 2021) may comprise a PHY header comprising a receiver address (RA) and a destination address (DA) of the PPDU. In an embodiment, as described above in FIG. 21, the PPDU from the source STA (e.g., PPDU 2121) may comprise a PHY header comprising a flag indicating low latency relaying and an RA of the PPDU. In an embodiment, as described above in FIG. 22, the PPDU from the source STA (e.g., PPDU 2221) may comprise a PHY header comprising a flag for low latency relaying. As shown in FIG. 26A, in an embodiment, the PHY header may be a PHY header of an Extremely High Throughput (EHT) multi-user (MU) PPDU 2610. EHT MU PPDU 2610 may comprise a PHY header, where PHY header may comprise non-high throughput (non-HT) signal field (L-SIG), repeated L-SIG (RL-SIG), universal signal field (U-SIG) and EHT signal field (EHT-SIG). EHT-SIG may further comprise a common field and a user specific field. User specific field may comprise multiple user fields to include RA and DA. In addition, indication for low latency relaying (i.e., flag) may be signaled in the user specific field, if it is used in the procedure.

In an embodiment, as described above in FIGS. 20-23, the PPDU from the source STA (e.g., PPDUs 2021, 2121, 2221, 2321) may comprise a MAC header comprising a receiver address (RA) and a destination address (DA) of a data unit of the PPDU. In an embodiment, as described above in FIG. 23, the MAC header may further comprise a flag for indication of low latency relaying. In an embodiment, the MAC header may be the MAC header of a MAC frame 2620 comprising address fields as explained in FIG. 4. In an embodiment, address fields 1, 2, 3 may comprise the RA and DA of the data unit. In another embodiment, there may be more than 3 address fields, including the address fields comprising the RA and DA. In addition, the indication for low latency relaying (e.g., flag) may be signaled in an HT control field of the MAC header, if it is used in the procedure.

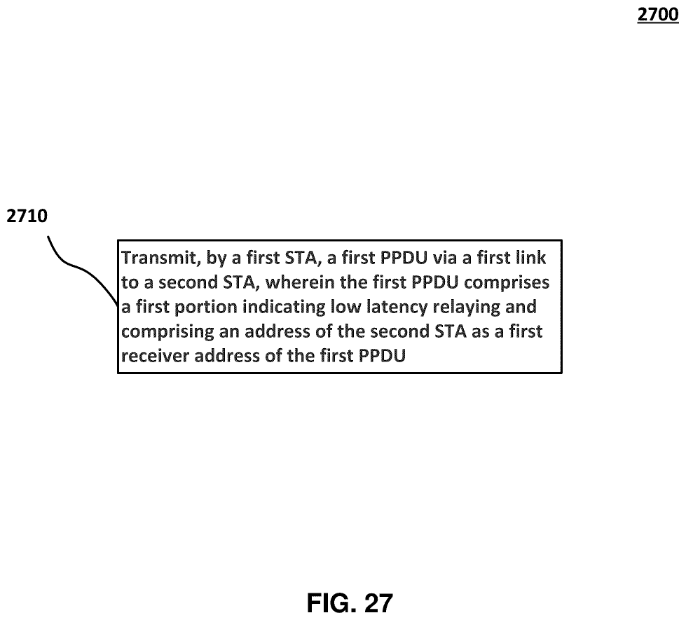

FIG. 27 illustrates an example process 2700 according to an embodiment. Example process 2700 is provided for the purpose of illustration only and is not limiting. Example process 2700 may be performed by a first STA, such as STA 2010 in FIGS. 20 and 21, for example. The first STA may comprise an MLD STA. The first STA may be an AP STA or a non-AP STA. The first STA may be a transmitting STA that has data for transmission to a second STA, where the second STA may relay the data to a third STA. The second STA may be an MLD relay. The first STA and the second STA may communicate over at least a first link and a second link.

As shown in FIG. 27, process 2700 may include, in step 2710, transmitting, by a first STA, a first PPDU via a first link to a second STA, where the first PPDU comprises a first portion indicating low latency relaying and comprising an address of the second STA as a first receiver address of the first PPDU. In an embodiment, the first portion may comprise a portion of a PHY header of the first PPDU. In an embodiment, the first portion may comprise an indication of low latency relaying. In an embodiment, the indication may comprise a flag. In another embodiment, the first portion may comprise a destination address of the first PPDU or a destination address of a data unit of the first PPDU. The data unit may comprise a low latency data frame. In an embodiment, based on the destination address being different than the first receiver address, the first portion may indicate low latency relaying.

In an embodiment, the first PPDU may further comprise a second portion. In an embodiment, the second portion may comprise a portion of the PHY header of the first PPDU and/or a portion of a MAC header comprised in the first PPDU. The MAC header may be a MAC header of the data unit of the first PPDU. In another embodiment, where the second portion comprises the MAC header, the second portion may comprise a second receiver address. In an embodiment, the second receiver address may be equal to the destination address of the first PPDU or to the destination address of the data unit comprised in the first PPDU. In an embodiment, the first PPDU may further comprise a frame body of a first MPDU.

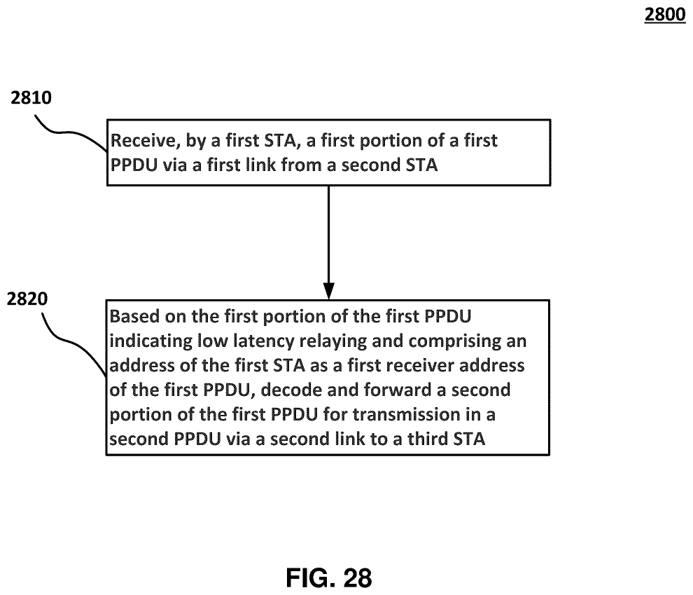

FIG. 28 illustrates another example process 2800 according to an embodiment. Example process 2800 is provided for the purpose of illustration only and is not limiting. Example process 2800 may be performed by a first STA, such as relay 2011 in FIGS. 20 and 21, for example. The first STA may comprise a MLD STA. The first STA may be an AP STA or a non-AP STA. The first STA may be an MLD relay. The first STA may receive a data transmission from a second STA. The second STA may also comprise an MLD. The first STA and the second STA may communicate over at least a first link and a second link. The first STA may transmit data to a third STA. The third STA may also comprise an MLD. The first STA and the third STA may communicate over at least a first link and a second link.

As shown in FIG. 28, process 2800 may include, in step 2810, receiving, by the first STA, a first portion of a first PPDU via a first link from the second STA. In an embodiment, the first portion may comprise a portion of a PHY header of the first PPDU.

In step 2820, process 2800 may include, based on the first portion of the first PPDU indicating low latency relaying and comprising an address of the first STA as a first receiver address of the first PPDU, decoding and forwarding a second portion of the first PPDU for transmission in a second PPDU via a second link to a third STA. In an embodiment, the first portion may comprise an indication of low latency relaying. In an embodiment, the indication may comprise a flag. In another embodiment, the first portion may comprise a destination address of the first PPDU or a destination address of a data unit of the first PPDU. The data unit may comprise a low latency data frame. In an embodiment, based on the destination address being different than the first receiver address, the first portion may indicate low latency relaying.

In an embodiment, the second portion may comprise a portion of a PHY header of the first PPDU and/or a portion of a MAC header comprised in the PPDU. The MAC header may be a MAC header of the data unit of the first PPDU. In another embodiment, where the second portion comprises the MAC header, the second portion may comprise a second receiver address. In an embodiment, the second receiver address may be equal to the destination address of the first PPDU or to the destination address of the data unit comprised in the first PPDU. As such, in an embodiment, forwarding the second portion of the first PPDU for transmission in the second PPDU may not comprise modifying the second portion.

In an embodiment, process 2800 may further comprise decoding and forwarding the second portion of the first PPDU for transmission in the second PPDU via the second link to the third STA, while receiving the first PPDU via the first link from the second STA. In an embodiment, process 2800 may further comprise transmitting a physical layer (PHY) header of the second PPDU before transmitting the second portion of the first PPDU in the second PPDU. In an embodiment, process 2800 may further comprise decoding and forwarding a third portion of the first PPDU for transmission in the second PPDU via the second link to the third STA, after transmitting the second portion of the first PPDU in the second PPDU. In an embodiment, the third portion of the first PPDU may be a portion of a frame body of a first MPDU of the first PPDU. In an embodiment, the first PPDU may comprise an MPDU. In an embodiment, the MPDU may be longer than 1 ms.

In an embodiment, process 2800 may further comprise transmitting, by the first STA to the second STA, an ACK frame via the first link, after a successful check of an FCS of the first PPDU. In another embodiment, process 2800 may further comprise not transmitting, by the first STA to the second STA, an ACK frame via the first link, after a failed check of an FCS of the first PPDU.

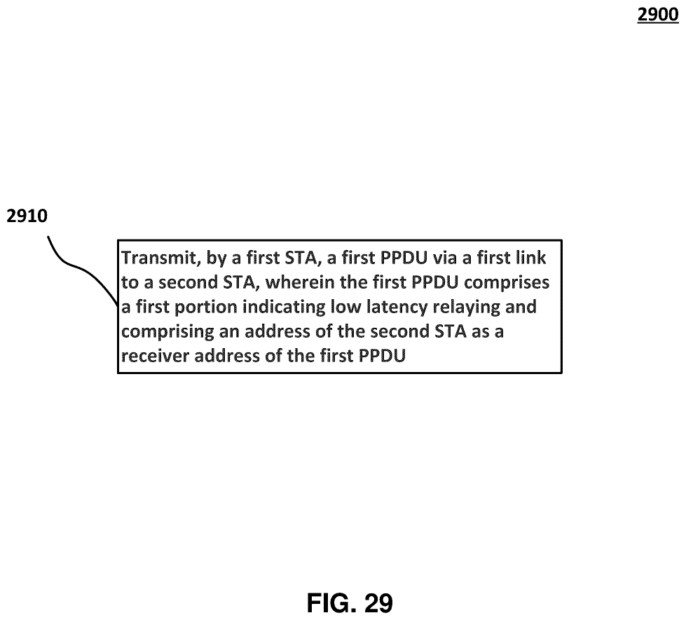

FIG. 29 illustrates another example process 2900 according to an embodiment. Example process 2900 is provided for the purpose of illustration only and is not limiting. Example process 2900 may be performed by a first STA, such as STA 2010 in FIGS. 22 and 23, for example. The first STA may comprise an MLD STA. The first STA may be an AP STA or a non-AP STA. The first STA may be a transmitting STA that has data for transmission to a second STA, where the second STA may relay the data to a third STA. The second STA may be an MLD relay. The first STA and the second STA may communicate over at least a first link and a second link.

As shown in FIG. 29, process 2900 may include, in step 2910, transmitting, by a first STA, a first PPDU via a first link to a second STA, where the first PPDU comprises a first portion indicating low latency relaying and comprising an address of the second STA as a receiver address of the first PPDU. In an embodiment, the first portion may comprise a portion of a PHY header and a portion of a MAC header of the first PPDU. In an embodiment, the first portion may comprise an indication of low latency relaying in the PHY header or in the MAC header. In an embodiment, the indication may comprise a flag. In an embodiment, the receiver address of the first PPDU or a receiver address of a data unit of the first PPDU may be in the MAC header of the first PPDU.

In an embodiment, the first PPDU may further comprise a second portion. In an embodiment, the second portion may comprise a portion of a MAC header comprised in the first PPDU. The MAC header may be the MAC header of a data unit of the first PPDU. The data unit may comprise a low latency data frame. In an embodiment, the second portion may comprise a destination address of the first PPDU and/or a destination address of the data unit of the first PPDU, and the destination address may not be equal to the receiver address of the first PPDU. In an embodiment, process 2900 may further comprise a third portion, where the third portion of the first PPDU may comprise a portion of a frame body of a first MPDU of the first PPDU.

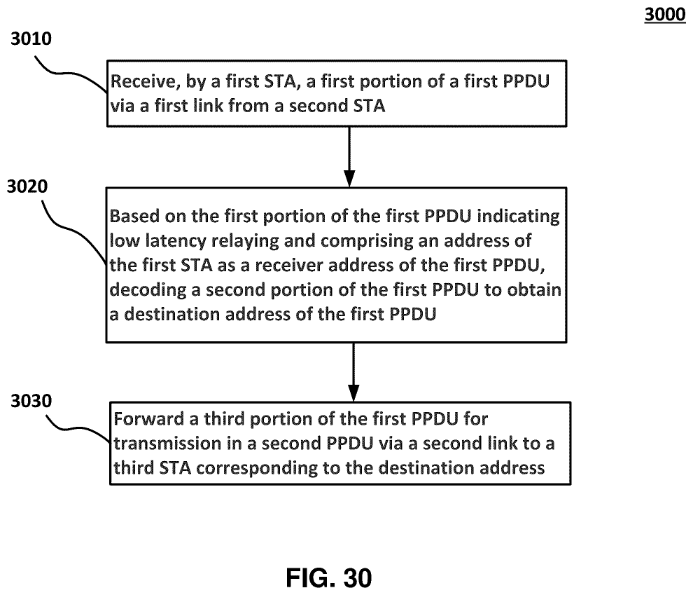

FIG. 30 illustrates another example process 3000 according to an embodiment. Example process 3000 is provided for the purpose of illustration only and is not limiting. Example process 3000 may be performed by a first STA, such as relay 2011 in FIGS. 22 and 23, for example. The first STA may comprise an MLD. The first STA may be an AP STA or a non-AP STA. The first STA may be an MLD relay. The first STA may receive a data transmission from a second STA. The second STA may also comprise an MLD. The first STA and the second STA may communicate over at least a first link and a second link. The first STA may transmit data to a third STA. The third STA may also comprise an MLD. The first STA and the third STA may communicate over at least the first link and the second link.

As shown in FIG. 30, process 3000 may include, in step 3010, receiving, by the first STA, a first portion of a first PPDU via a first link from the second STA. In an embodiment, the first portion may comprise a portion of a PHY header of the first PPDU and a portion of a MAC header comprised in the first PPDU. The MAC header may be a MAC header of a data unit of the first PPDU. The data unit may comprise a low latency data frame.

In step 3020, process 3000 may include, based on the first portion of the first PPDU indicating low latency relaying and comprising an address of the first STA as a receiver address of the first PPDU, decoding a second portion of the first PPDU to obtain a destination address of the first PPDU or a destination address of the data unit. In an embodiment, the first portion may comprise an indication of low latency relaying in the PHY header of the first PPDU or in the MAC header comprised in the first PPDU. In an embodiment, the indication may comprise a flag. In an embodiment, the receiver address of the first PPDU may be in the MAC header comprised in the first PPDU.

In an embodiment, the second portion may comprise a portion of the MAC header comprised in the first PPDU. In an embodiment, where the second portion comprises the destination address of the first PPDU, the destination address of the first PPDU or of the data unit may not be equal to the receiver address of the first PPDU. In an embodiment, process 3000 may further comprise setting the destination address of the first PPDU or of the data unit as a receiver address of the second PPDU.

In step 3030, process 3000 may include forwarding a third portion of the first PPDU for transmission in a second PPDU via a second link to a third STA corresponding to the destination address. In an embodiment, the third portion of the first PPDU may comprise a portion of a frame body of a first MPDU of the first PPDU. In an embodiment, process 3000 may further comprise forwarding the third portion of the first PPDU for transmission in the second PPDU via the second link to the third STA, while receiving the first PPDU via the first link from the second STA. In an embodiment, process 3000 may further comprise transmitting a PHY header and a MAC header of the second PPDU before transmitting the third portion of the first PPDU in the second PPDU. In an embodiment, the first PPDU may comprise an MPDU. In an embodiment, the MPDU may be longer than 1 ms.

In an embodiment, process 3000 may further comprise transmitting, by the first STA to the second STA, an ACK frame via the first link, after a successful check of an FCS of the first PPDU. In another embodiment, process 3000 may further comprise not transmitting, by the first STA to the second STA, an ACK frame via the first link, after a failed check of an FCS of the first PPDU.

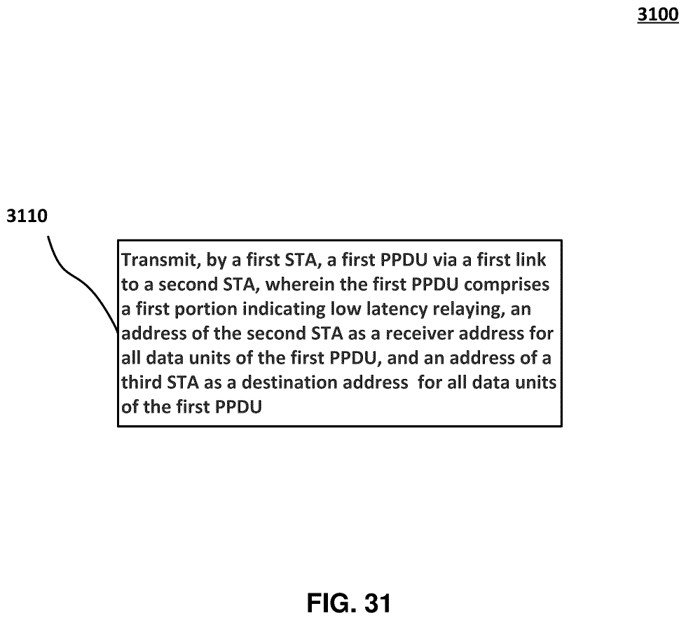

FIG. 31 illustrates another example process 3100 according to an embodiment. Example process 3100 is provided for the purpose of illustration only and is not limiting. Example process 3100 may be performed by a first STA, such as STA 2010 in FIG. 24, for example. The first STA may comprise an MLD. The first STA may be an AP STA or a non-AP STA. The first STA may be a transmitting STA that has data for transmission to a second STA, where the second STA may relay the data to a third STA. The second STA may be an MLD relay. The first STA and the second STA may communicate over at least a first link and a second link.

As shown in FIG. 31, process 3100 may include, in step 3110, transmitting, by the first STA, a first PPDU via a first link to the second STA, where the first PPDU may comprise a first portion indicating low latency relaying, an address of the second STA as a receiver address for all data units of the first PPDU, and/or an address of a third STA as a destination address for all data units of the first PPDU. In an embodiment, the first portion may comprise an indication of: low latency relaying, that the receiver address is the same for all data units of the first PPDU, and that the destination address is the same for all data units of the first PPDU. In an example, the indication of low latency relaying, that the receiver address is the same for all data units of the first PPDU, and that the destination address is the same for all data units of the first PPDU comprises a one-bit flag.

In an embodiment, the first portion may comprise a portion of a first data unit of the first PPDU. In an embodiment, the first data unit may comprise a first MPDU of the first PPDU.

In an embodiment, the first portion may comprise a portion of a PHY header of the first PPDU and/or a portion of a MAC header comprised in the first PPDU. The MAC header may be a MAC header of a data unit of the first PPDU. The data unit may comprise a low latency data frame. In an embodiment, the first portion may be in the MAC header comprised in the first PPDU.

In an embodiment, the first PPDU may further comprise a second portion. In an embodiment, the second portion may comprise a second data unit of the first PPDU. In an embodiment, the second data unit comprises a second MPDU of the first PPDU.

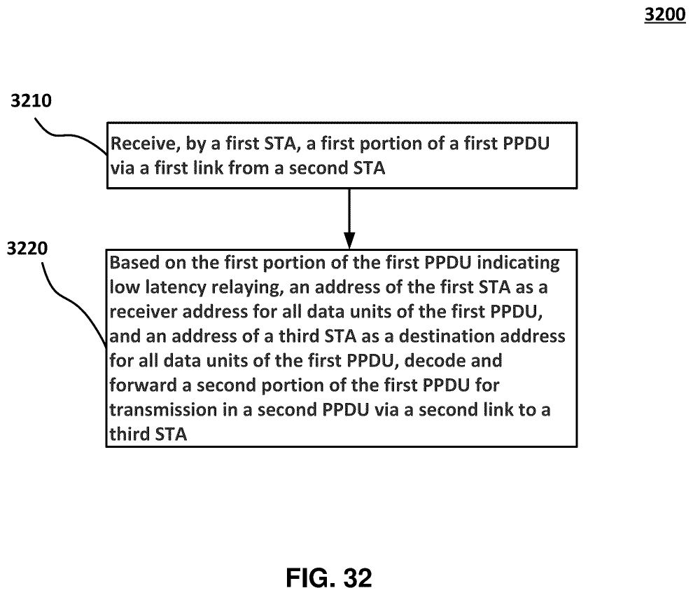

FIG. 32 illustrates another example process 3200 according to an embodiment. Example process 3200 is provided for the purpose of illustration only and is not limiting. Example process 3200 may be performed by a first STA, such as relay 2011 in FIG. 24, for example. The first STA may comprise an MLD. The first STA may be an AP STA or a non-AP STA. The first STA may be an MLD relay. The first STA may receive a data transmission from a second STA. The second STA may also comprise an MLD. The first STA and the second STA may communicate over at least a first link and a second link. The first STA may transmit data to a third STA. The third STA may also comprise an MLD. The first STA and the third STA may communicate over at least the first link and the second link.

As shown in FIG. 32, process 3200 may include, in step 3210, receiving, by the first STA, a first portion of a first PPDU via a first link from the second STA. In an embodiment, the first portion may comprise a first data unit of the first PPDU. The first data unit may comprise a low latency data frame.

In step 3220, process 3200 may include, based on the first portion of the first PPDU indicating low latency relaying, an address of the first STA as a receiver address for all data units of the first PPDU, and an address of a third STA as a destination address for all data units of the first PPDU, decoding and forwarding a second portion of the first PPDU for transmission in a second PPDU via a second link to a third STA. In an embodiment, the first portion may comprise an indication of: low latency relaying, that the receiver address is the same for all data units of the first PPDU, and that the destination address is the same for all data units of the first PPDU. In an example, the indication of low latency relaying, that the receiver address is the same for all data units of the first PPDU, and that the destination address is the same for all data units of the first PPDU comprises a one-bit flag.

In an embodiment, the first portion may comprise a portion of a first data unit of the first PPDU. In an embodiment, the first data unit may comprise a first MPDU of the first PPDU. In an embodiment, process 3200 may further comprise performing a frame check sequence (FCS) of a first data unit of the first PPDU.

In an embodiment, the first portion may comprise a portion of a PHY header of the first PPDU and/or a portion of a MAC header comprised in the first PPDU. The MAC header may be a MAC header of a data unit of the first PPDU. The data unit may comprise a low latency data frame. In an embodiment, the first portion may be in the MAC header comprised in the first PPDU.

In an embodiment, the second portion may comprise a second data unit of the first PPDU. In an embodiment, process 3200 may further comprise setting the destination address of the first PPDU as a receiver address in a MAC header of at least one data unit of the second PPDU. In another embodiment, setting the destination address of the first PPDU as a receiver address in a MAC header of at least one data unit of the second PPDU may comprise setting the destination address of the first PPDU as a receiver address in MAC headers of all data units of the second PPDU. In an embodiment, process 3200 may further comprise forwarding the first portion of the first PPDU for transmission in the second PPDU via the second link to the third STA, while receiving the second portion of the first PPDU via the first link from the second STA.

In an embodiment, process 3200 may further comprise transmitting, by the first STA to the second STA, an ACK frame via the first link, after a successful check of FCSs of all data units of the first PPDU. In another embodiment, process 3200 may further comprise not transmitting, by the first STA to the second STA, an ACK frame via the first link, after a failed check of an FCS of at least one data unit of the first PPDU.

What is claimed is:

1. A first station (STA) comprising:
one or more processors; and
memory storing instructions that, when executed by the one or more processors, cause the first STA to:
receive a first portion of a first physical layer protocol data unit (PPDU) via a first link from a second STA; and
based on the first portion of the first PPDU indicating low latency relaying and comprising an address of the first STA as a first receiver address of the first PPDU, decode and forward a second portion of the first PPDU for transmission in a second PPDU via a second link to a third STA.

2. The first STA of claim 1, wherein the first portion comprises a portion of a physical layer (PHY) header of the first PPDU.

3. The first STA of claim 1, wherein the first portion comprises an indication of low latency relaying.

4. The first STA of claim 3, wherein the indication comprises a flag.

5. The first STA of claim 1, wherein the first portion comprises a destination address of the first PPDU or a destination address of a data unit of the first PPDU.

6. The first STA of claim 1, wherein forwarding the second portion of the first PPDU for transmission in the second PPDU does not comprise modifying the second portion.

7. The first STA of claim 1, wherein the instructions further cause the cause the first STA to decode and forward the second portion of the first PPDU for transmission in the second PPDU via the second link to the third STA, while receiving the first PPDU via the first link from the second STA.

8. A first station (STA) comprising:
one or more processors; and
memory storing instructions that, when executed by the one or more processors, cause the first STA to:
transmit a first physical layer protocol data unit (PPDU) via a first link to a second STA, wherein the first PPDU comprises a first portion indicating low latency relaying and comprising an address of the second STA as a first receiver address of the first PPDU.

9. The first STA of claim 8, wherein the first portion comprises a portion of a physical layer (PHY) header of the first PPDU.

10. The first STA of claim 8, wherein the indication comprises a flag.

11. The first STA of claim 8, wherein the first portion comprises a destination address of the first PPDU or a destination address of a data unit of the first PPDU.

12. The first STA of claim 11, wherein the first portion indicates low latency relaying based on the destination address being different than the first receiver address.

13. The first STA of claim 8, wherein the first PPDU further comprises a second portion.

14. The first STA of claim 13, wherein the second portion comprises a portion of a physical layer (PHY) header of the first PPDU or a medium access control (MAC) header of the data unit of the first PPDU.

15. A non-transitory computer-readable medium comprising instructions that, when executed by one or more processors of a first station (STA), cause the first STA to:
receive a first portion of a first physical layer protocol data unit (PPDU) via a first link from a second STA; and
based on the first portion of the first PPDU indicating low latency relaying and comprising an address of the first STA as a first receiver address of the first PPDU, decode and forward a second portion of the first PPDU for transmission in a second PPDU via a second link to a third STA.

16. The non-transitory computer-readable medium of claim 15, wherein the first portion comprises a portion of a physical layer (PHY) header of the first PPDU.

17. The non-transitory computer-readable medium of claim 15, wherein the first portion comprises an indication of low latency relaying.

18. The non-transitory computer-readable medium of claim 15, wherein the first portion comprises a destination address of the first PPDU or a destination address of a data unit of the first PPDU.

19. The non-transitory computer-readable medium of claim 15, wherein forwarding the second portion of the first PPDU for transmission in the second PPDU does not comprise modifying the second portion.

20. The non-transitory computer-readable medium of claim 15, wherein the instructions further cause the cause the first STA to decode and forward the second portion of the first PPDU for transmission in the second PPDU via the second link to the third STA, while receiving the first PPDU via the first link from the second STA.
